(19) United States
(12) Patent Application Publication
(10) Pub. No.: US 2024/0104013 A1
(43) Pub. Date: Mar. 28, 2024

(54) DETERMINISTIC ADJACENT OVERFLOW DETECTION FOR SLOTTED MEMORY POINTERS

(71) Applicant: Intel Corporation, Santa Clara, CA (US)

(72) Inventors: Michael LeMay, Hillsboro, OR (US); David M. Durham, Beaverton, OR (US)

(73) Assignee: Intel Corporation, Santa Clara, CA (US)

(21) Appl. No.: 17/936,011

(22) Filed: Sep. 28, 2022

(51) Int. Cl. G06F 12/02; G06F 12/14

(52) U.S. Cl. CPC G06F 12/0223; G06F 12/14; G06F 2212/7202

(57) ABSTRACT

A processor includes a processing core having a register to store an encoded pointer for a memory address to a memory allocation of a memory, the encoded pointer including a first even odd slot (EOS) bit set to a first value and a second EOS bit set to a second value; and circuitry to receive a memory access request based on the encoded pointer; and in response to determining that the first value matches the second value, perform a memory operation corresponding to the memory access request.

### FIELD

The present disclosure relates in general to the field of computer security, and more specifically, to memory safety by detecting adjacent overflows for slotted memory pointers in a computing system.

### BACKGROUND

Memory safety enforcement is a priority that is both longstanding and urgent for users of computing systems. On approach used by hackers is to purposefully access memory beyond legitimate bounds. This is called an underflow or overflow, or sometimes a memory access that is out of bounds (OOB). Some users accept probabilistic detection of some types of memory safety violations, but efficient and deterministic detection of adjacent underflows and overflows is desirable to increase the security of the computing system.

### BRIEF DESCRIPTION OF THE DRAWINGS

FIG. 1 is a schematic diagram of an illustrative encoded pointer architecture according to one embodiment.

FIG. 2 is a schematic illustration of a memory allocation system using tag metadata according to an embodiment.

FIG. 3 is a graphical representation of a memory space illustrating a binary tree and the selection of the correct tag metadata location in a tag table.

FIG. 4 is a graphical representation of a tag table and entries for an allocation assigned to a slot that includes at least two granules.

FIG. 5 is a table illustrating possible tag table entry arrangements according to at least one embodiment.

FIG. 6 is a graphical representation of a tag table and entries for an allocation assigned to a slot that includes four granules.

FIG. 7(A) is a schematic diagram of another illustrative encoded pointer architecture according to one embodiment.

FIG. 7(B) is a schematic diagram of yet another illustrative encoded pointer architecture according to one embodiment.

FIG. 8 is a diagram of a potential error scenario.

FIG. 9 is a diagram of a one tag 48-bit pointer encoding with deterministic out of bounds (OOB) detection across slots according to an embodiment.

FIG. 10 is a flow diagram of OOB detection processing according to an embodiment.

FIG. 11 is a diagram of a sample one tag 52-bit pointer encoding with deterministic OOB detection across slots according to an embodiment.

FIG. 12 is a diagram of a sample one tag 53-bit pointer encoding with deterministic OOB detection across slots according to an embodiment.

FIG. 13 is a diagram of another sample one tag 48-bit pointer encoding with deterministic OOB detection across slots according to an embodiment.

FIG. 14 is a diagram of a software view and a hardware view of a one tag pointer encoding with deterministic OOB detection across slots according to an embodiment.

FIG. 15 is a diagram of yet another sample one tag 48-bit pointer encoding with deterministic OOB detection across slots according to an embodiment.

FIG. 16 is a diagram of a linear address masking (LAM) pointer encoding according to an embodiment.

FIG. 17 illustrates an example computing system.

FIG. 18 illustrates a block diagram of an example processor and/or System on a Chip (SoC) that may have one or more cores and an integrated memory controller.

FIG. 19(A) is a block diagram illustrating both an example in-order pipeline and an example register renaming, out-of-order issue/execution pipeline according to examples.

FIG. 19(B) is a block diagram illustrating both an example in-order architecture core and an example register renaming, out-of-order issue/execution architecture core to be included in a processor according to examples.

FIG. 20 illustrates examples of execution unit(s) circuitry.

FIG. 21 is a block diagram of a register architecture according to some examples.

FIG. 22 illustrates examples of an instruction format.

FIG. 23 illustrates examples of an addressing information field.

FIG. 24 illustrates examples of a first prefix.

FIGS. 25(A)-(D) illustrate examples of how the R, X, and B fields of the first prefix in FIG. 24 are used.

FIGS. 26(A)-(B) illustrate examples of a second prefix.

FIG. 27 illustrates examples of a third prefix.

FIG. 28 is a block diagram illustrating the use of a software instruction converter to convert binary instructions in a source instruction set architecture to binary instructions in a target instruction set architecture according to examples.

### DETAILED DESCRIPTION

The present disclosure provides various possible embodiments, or examples, of systems, methods, apparatuses, architectures, and machine-readable media for memory safety with a single memory tag per allocation. In particular, embodiments disclosed herein provide the same or similar security guarantees of typical memory tagging (e.g., one tag per 16-byte granule), but use only one memory tag set per allocation regardless of size. This offers an order of magnitude performance advantage and lower memory overhead. In some embodiments, the technology described herein overcomes a tradeoff between high metadata overheads and a lack of determinism in detecting adjacent underflows and overflows.

Numerous memory safety techniques use tags to protect memory. Memory Tagging Extensions (MTE) offered by ARM Limited, Memory Tagging Technology (MTT), Data Corruption Detection, and scalable processor architecture (SPARC) Application Data Integrity (ADI) offered by Oracle Corporation, all match a memory tag with a pointer tag per granule of data accessed from memory. The matching is typically performed on a memory access instruction (e.g., on a load/store instruction). Matching a memory tag with a pointer tag per granule of data (e.g., 16-byte granule) can be used to determine if the current pointer is accessing memory currently allocated to that pointer. If the tags do not match, an error is generated.

With existing memory tagging solutions such as MTT, MTE, etc., a tag must be set for every granule of memory allocated. By way of example, at 16-bytes granularity, on a memory allocation operation (e.g., malloc, calloc, free, etc.), a 16 MB allocation requires more than one million set tag instructions to be executed and over one million tags set. This produces an enormous power and performance penalty as well as introducing memory overhead.

A memory safety system as disclosed herein can resolve many of the aforementioned issues (and more). In one or more embodiments, a memory safety system provides an encoding for finding just one memory tag per memory allocation, regardless of allocation size. This is achieved with a unique linear pointer encoding that identifies the location of tag metadata, for a given size and location of a memory allocation. A tag in the pointer is then matched with the single memory tag located in a linear memory table for any granule of memory, along with bounds and other memory safety metadata.

In one or more embodiments, a memory safety system offers significant advantages. Embodiments provide orders of magnitude advantage over setting potentially millions of tags in existing technologies where a tag is applied to every 16-byte memory granule. In addition, embodiments herein enable a single tag lookup a memory access operation (e.g., load/store). Furthermore, only one tag needs to be set per allocation, which can save a large amount of memory and performance overhead, while still offering the security and memory safety of existing memory tagging.

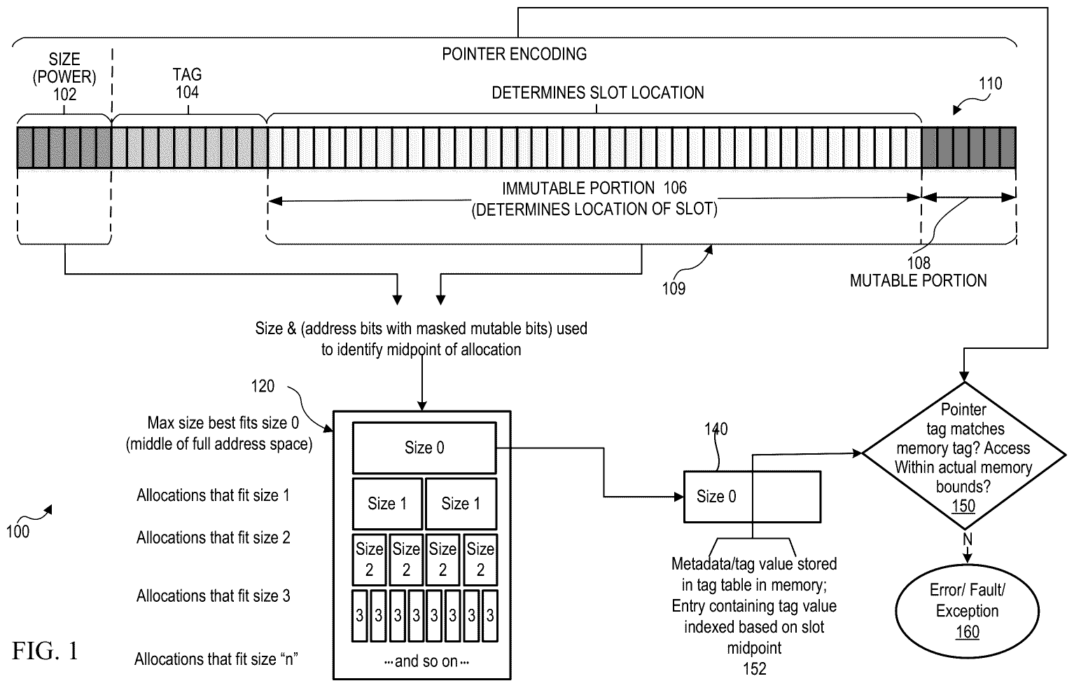

FIG. 1 is a diagram of an example encoded pointer architecture and tag checking operation 100. FIG. 1 illustrates an encoded pointer 110 that may be used in one or more embodiments of a memory safety system disclosed herein. The encoded pointer 110 may be configured as any bit size, such as, for example, a 64-bit pointer (as shown in FIG. 1), or a 128-bit pointer, or a pointer that is larger than 128-bits. The encoded pointer, in one embodiment, may include an x86 architecture pointer. The encoded pointer 110 may include a greater (e.g., 128-bits), or lesser (e.g., 16-bits, 32-bits) number of bits. In an embodiment, the encoded pointer is stored in a general-purpose register in the processor, the same way that a linear address is stored in conventional processors, with the processor checking address bits during load/store operations.

FIG. 1 shows a 64-bit pointer (address) in its base format, using exponent size (power) metadata. The encoded pointer 110 includes a multi-bit size (power) metadata field 102, a multi-bit tag field 104, and a multi-bit address field 109 that includes an immutable portion 106 and a mutable portion 108 that can be used for pointer arithmetic. The encoded pointer 110 is an example configuration that may be used in one or more embodiments and may be the output of special address encoding logic that is invoked when memory is allocated (e.g., by an operating system, in the heap or in the stack, in the text/code segment) and provided to executing programs in any of a number of different ways, including by using a function such as malloc, alloc, calloc, or new; or implicitly via the loader; or statically allocating memory by the compiler, etc. As a result, an indirect address (e.g., a linear address) that points to the allocated memory, is encoded with metadata, which is also referred to herein as ‘pointer metadata’ (e.g., size/power in size metadata field 102, tag value in tag field 104) and, in at least some embodiments, is partially encrypted.

In embodiments, the number of bits used in the immutable portion 106 and mutable portion 108 of the address field 109 may be based on the size of the respective memory allocation as expressed in the size metadata field 102. For example, in general, a larger memory allocation (2⁰) may require a lesser number of immutable address bits than a smaller memory allocation (2¹ to 2ⁿ). The immutable portion 106 may include any number of bits, although, it is noted that, in the shown embodiment of FIG. 1, the size number in fact does not correspond to the “power of 2” (Po2) slot size. For example, the immutable portion 106 may accommodate memory addresses having: 8-bits or more; 16-bits or more, 32-bits or more; 48-bits or more; 52-bits or more; 64-bits or more; 128-bits or more.

In the example shown, the address field 109 may include a linear address (or a portion thereof). The size metadata field 102 indicates a size (e.g., number of bits) in mutable portion 108 of the encoded pointer 110. A number of low order address bits that comprise the mutable portion (or offset) 108 of the encoded pointer 110 may be manipulated freely by software for pointer arithmetic. In some embodiments, the size metadata field 102 may include power (exponent) metadata bits that indicate a size based on a power of two. Other embodiments may use a different power (exponent). For ease of illustration, encoded pointer 110 of FIG. 1 will be assumed to have a power of two (Po2) size metadata encoding. Another metadata field, such as tag field 104, can include a tag that is unique to the particular pointer within the process for which the pointer was created. In some embodiments, other metadata may also be encoded in encoded pointer 110 including, but not necessarily limited to, one or more of a domain identifier or other information that uniquely identifies the domain (e.g., user application, library, function, etc.) associated with the pointer, version, or any other suitable metadata.

The size metadata field 102 may indicate the number of bits that compose the immutable portion 106 and the mutable plaintext portion 108. In certain embodiments, the sizes of the respective address portions (e.g., immutable portion 106 and mutable portion 108) are dictated by the Po2 size metadata field 102. For example, if the Po2 size metadata value is 0 (bits: 000000), no mutable plaintext bits are defined and all of the address bits in the address field 109 form an immutable portion. As further examples, if the power size metadata value is 1 (bits: 000001), then a 1-bit mutable plaintext portion and a 47-bit immutable portion are defined, if the power size metadata value is 2 (bits: 000010), then a 2-bit mutable portion and a 46-bit immutable portion are defined, and so on, up to a 48-bit mutable plaintext portion with no immutable bits.

In the example of FIG. 1, the Po2 size metadata equals 6 (bits: 000110), resulting in a 6-bit mutable portion 108 and a 42-bit immutable portion 106. The mutable portion 108 may be manipulated by software, e.g., for pointer arithmetic or other operations. In some cases, the Po2 size metadata field 102 could be provided as a separate parameter in addition to the pointer; however, in some cases (e.g., as shown) the bits of the Po2 size metadata field 102 may be integrated with the encoded pointer 110 to provide legacy compatibility in certain cases.

It should also be noted that in an alternative scenario, the Po2 size metadata field 102 may indicate the number of bits that compose the immutable portion 106, and thus dictate the number of bits remaining to make up the mutable portion 108. For example, if the Po2 size metadata value is 0 (bits: 000000), there are no immutable plaintext bits (in immutable portion 106) and all remaining lower address bits in the address field 109 form a mutable portion 108 and may be manipulated by software using pointer arithmetic. As further examples, if the Po2 size metadata value is 1 (bits: 000001), then there is a 1-bit immutable portion and a 31-bit mutable portion, if the Po2 size metadata value is 2 (bits: 000010), then there is a 2-bit immutable portion and a 30-bit mutable plaintext portion, and so on, up to a 32-bit immutable portion with no mutable bits where no bits can be manipulated by software.

In at least one embodiment, in encoded pointer 110, the address field 109 is in plaintext, and encryption is not used. In other embodiments, however, an address slice (e.g., upper 16 bits of address field 109) may be encrypted to form a ciphertext portion of the encoded pointer 110. In some scenarios, other metadata encoded in the pointer (but not the size metadata) may also be encrypted with the address slice. The ciphertext portion of the encoded pointer 110 may be encrypted with a small tweakable block cipher (e.g., a SIMON, SPECK, BipBip, or tweakable K-cipher at a 16-bit block size, 32-bit block size, or other variable bit size tweakable block cipher). Thus, the address slice to be encrypted may use any suitable bit-size block encryption cipher. If the number of ciphertext bits is adjusted (upward or downward), the remaining address bits to be encoded (e.g., immutable and mutable portions) may be adjusted accordingly. The tweak may include one or more portions of the encoded pointer. For example, the tweak may include the size metadata in the size metadata field 102, the tag metadata in the tag field 104, some or all the immutable portion 106. If the immutable portion of the encoded pointer is used as part of the tweak, then the immutable portion 106 of the address cannot be modified by software (e.g., pointer arithmetic) without causing the ciphertext portion to decrypt incorrectly. Other embodiments may utilize an authentication code in the pointer for the same.

When a processor is running in a cryptographic mode and accessing memory using an encoded pointer such as encoded pointer 110, to get the actual linear/virtual address memory location, the processor takes the encoded address format and decrypts the ciphertext portion. Any suitable cryptography may be used and may optionally include as input a tweak derived from the encoded pointer. In one example, a tweak may include the variable number of immutable plaintext bits (e.g., 106 in FIG. 1) determined by the size/power/exponent metadata bits (e.g., 102 of FIG. 1) and a secret key. In some instances, the size/power/exponent metadata and/or other metadata or context information may be included as part of the tweak for encrypting and decrypting the ciphertext portion (also referred to herein as “address tweak”). In one or more embodiments, all of the bits in the immutable portion 106 may be used as part of tweak. If the address decrypts incorrectly, the processor may cause a general protection fault (#GP) or page fault due to the attempted memory access with corrupted linear/virtual address.

A graphical representation of a memory space 120 illustrates possible memory slots to which memory allocations for various encodings in the Po2 size metadata field 102 of encoded pointer 110 can be assigned. Each address space portion of memory, covered by a given value of the immutable portion 106 contains a certain number of allocation slots (e.g., one Size 0 slot, two Size 1 slots, four Size 2 slots, etc.) depending on the width of the Po2 size metadata field 102.

Referring still to FIG. 1, the size metadata field 102, in combination with the information in the address fields (e.g., immutable portion 106 with masked mutable portion 108), can allow the processor to find the midpoint of a given slot defined in the memory space 120. The size metadata, which is expressed as a power of two in this example, is used to select slot that best fits the entire memory allocation. For a power of two scheme, where the size metadata includes size exponent information, as the size exponent becomes larger (for larger slots, such as Size 0), fewer upper address bits (e.g., immutable portion 106) are needed to identify a particular slot (since with larger slots, there will be fewer slots to identify). In such a case, more of the bits at the end of the pointer, in the bits of mutable portion 108 (e.g., where pointer arithmetic can be performed), can be used to range within a given slot. The latter leads to a shrinking of the address field and an expanding of the pointer arithmetic field.

FIG. 1 illustrates a pointer format for locating tag metadata for any allocation. Tag data in a pointer allows multiple versions of a pointer to be used pointing to the same slot, while still ensuring that the pointer version being used to access the slot is in fact the pointer with the right to access that slot. The use of tag data can be useful for mitigating user-after-free (UAF) attacks for example. Where a dangling pointer is involved, but where tag data is used, changing tags with each version of the pointer would result in a mismatch with an allocation sought to be accessed by a dangling pointer, leading to errors and thus protecting the new allocation from unauthorized access by the dangling pointer.

As depicted in FIG. 1, upon execution of an instruction that includes a memory operation, according to one embodiment, processor circuitry and/or an integrated memory controller (IMC) compares at 150 the tag value included in the tag field 104 with the tag metadata 152 stored in metadata storage in memory. In one example, the metadata storage may include a tag table. The tag metadata 152 may be indexed in the tag table based on a midpoint of a slot 140 in memory to which the memory allocation is assigned. As will be further discussed herein, for each memory allocation, the tag table stores allocation metadata in metadata storage in memory. The allocation metadata for a particular memory allocation includes tag metadata (e.g., 152), which represents the memory allocation. For larger allocations, the allocation metadata may also include a descriptor and appropriate bounds information. If the tag data included in the tag field 104 matches the metadata 152 stored in the metadata storage in memory, and if any other metadata checks (e.g., memory access bounds checks) also succeed, then the processor circuitry and/or the IMC completes the requested memory operation in the memory circuitry/cache circuitry. If the tag data included in the tag field 104 fails to match the metadata 152 stored in the metadata storage in memory, then the IMC reports an error, fault, or exception 160 to the processor circuitry.

In one or more embodiments, a single tag is stored for a memory allocation, resulting in a single tag lookup to verify that the encoded pointer is accessing the correct allocation. Using power-of-two slot locator and the address of the memory allocation determined from the pointer encoding, a slot to which the memory allocation is assigned can be located. A midpoint of the slot can be used to search metadata storage to find the location of the allocation metadata (e.g., tag, descriptor, bounds information) for the given allocation. For memory allocation operations, such as alloc, realloc, and free, only one memory access is needed to set/reset the tag data. Additionally, as few as one memory access is needed for pointer lookups on load/store operations.

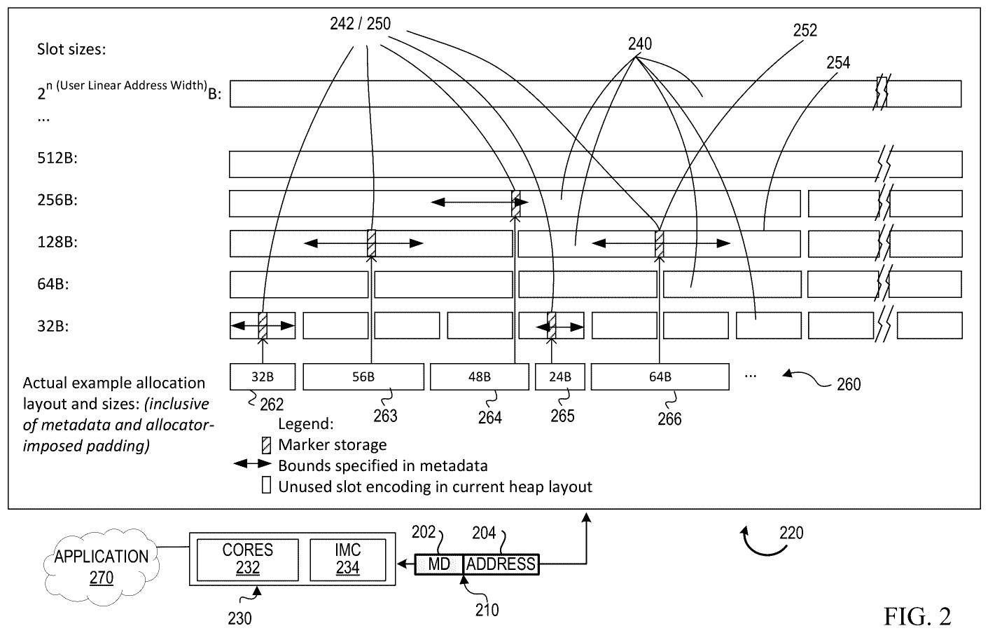

FIG. 2 is a schematic diagram of an illustrative memory/cache 220 to allow tag metadata checks on memory allocations accessed by encoded pointers (e.g., encoded pointer 110), some of which are described herein. The schematic diagram also shows processor circuitry 230 including cores 232 and memory controller circuitry 234 (e.g., memory controller (MC), integrated memory controller (IMC), memory management unit (MMU)), which are communicatively coupled to memory/cache 220. Although embodiments are not so limited, in the shown embodiment of FIG. 2 the memory/cache 220 may be apportioned, conceptually, into one or more power of two (i.e., 2⁰ to 2ⁿ) slots 240 in which the respective midpoint addresses 242 includes respective, unique, metadata regions 250 that are associated with respective memory allocations 260 within slots 240, in accordance with at least one embodiment described herein. Additionally, “allocation” and “memory allocation” are intended to refer to an addressable portion of memory in which an object, such as data or code, is stored. As used herein, “slot” is intended to refer to a unit of memory in a cacheline or across multiple cachelines.

In some embodiments, an instruction that causes the processor circuitry 230 to allocate memory causes an encoded pointer 210 (which may be similar to encoded pointer 110) to be generated. The encoded pointer may include at least data representative of the linear address associated with the targeted memory allocation 260 and metadata 202 (such as size/power in size field 102 and tag value in tag field 104) associated with the respective memory allocation 260 corresponding to memory address 204. Also, an instruction that causes the processor circuitry 230 to perform a memory operation (e.g., LOAD, MOV, STORE) that targets a particular memory allocation (e.g., 266) causes the memory controller circuitry 234 to access that memory allocation, which is assigned to a particular slot (e.g., 254) in memory/cache 220 using the encoded pointer 210.

In the embodiments of the memory/cache 220 of FIG. 2, each memory allocation 260 is fully assigned to a given slot (i.e., one memory allocation per slot and one slot per memory allocation), in this way ensuring that the metadata region 250 at the midpoint can be easily associated with the memory allocation to which it pertains. Embodiments, however, are not so limited, and include within their scope the provision of metadata (e.g., tag table information) within a slot that includes none, some, or all the memory allocation to which the metadata pertains. The memory allocations 260 are shown in FIG. 2 once at the bottom of the figure and represented correspondingly by double pointed arrows within the respective slots 240 to which the memory allocations are assigned. Even though the memory allocations 260 may be assigned to slots larger than the allocations themselves, the allocations may, according to one embodiment, not need padding in order to be placed within the larger slots.

According to some embodiments, a memory allocation may be assigned to a slot that most tightly fits the allocation, given the set of available slots and allocations. In the shown embodiment of FIG. 2, for example, the 32B allocation is assigned to a 32B slot, the 56B allocation to a 128B slot, the 48B allocation to a 256B slot, the 24B allocation to a 32B slot and the 64B allocation to a 128B slot. In the shown example of FIG. 2, because the 48B allocation would have crossed an alignment boundary within two slots, it is assigned to the larger 128B slot. Although the example of FIG. 2 shows the memory allocations as spanning through the slots in a contiguous fashion (tightly packed), clearly, embodiments are not so limited, and include within their scope a scheme of memory allocations to respective, dedicated memory slots as long as a midpoint address of the slot is crossed by the allocation, where some slots may be free, especially for example in UAF scenario where a dangling pointer is involved. According to some embodiments, memory allocation sizes may be no smaller than half the width of a smallest slot in order for them to cross (i.e., to at least partially cover) the midpoint when assigned to a slot.

Based on the above allocation scheme, where each memory allocation is uniquely assigned to a dedicated slot, and crosses the slot midpoint, the metadata region 250 may be located at the midpoint address of the slot so that the processor is able to find the metadata region for a particular slot quickly and it is ensured to be at least partially contained within each memory allocation that is assigned to that particular slot, without having to go to a separate table or memory location to determine the metadata. The power-of-two (Po2) approach, used according to one embodiment, allows a unique mapping of each memory allocation to a Po2 slot, where the slot is used to provide the possibility to uniquely encode and encrypt each object stored in the memory allocations. According to some embodiments, metadata (e.g., tag table information) in metadata regions 250 may be encrypted as well. In some embodiments, metadata in the metadata regions 250 may not be encrypted.

At least some encoded pointers specify the size of the slot, such as the Po2 size of the slot as a size exponent in the metadata field of the pointer, that the allocation to be addressed fits into. The size determines the specific address bits to be referred to by the processor in order to determine the slot being referred to. Having identified the specific slot, the processor can go directly to the address of the metadata region of the identified slot in order to write the metadata in the metadata region or read out the current metadata at the metadata region. Embodiments are, however, not limited to Po2 schemes for the slots, and may include a scheme where the availability of slots of successively increasing sizes may be based on a power of an integer other than two or based on any other scheme.

Although the memory controller circuitry 234 is depicted in FIG. 2 as a separate box from the cores 232, the cores 232 may include all or a portion of the memory controller circuitry 234. Also, although the memory controller circuitry 234 is depicted in FIG. 2 as part of processor circuitry 230, in some embodiments, the processor circuitry 230, including address generation circuitry used for load/store operations, may be include all, a portion, or none of the memory controller circuitry 234.

In response to execution of a memory access instruction, the processor circuitry 230 uses an encoded pointer 210 that includes at least data representative of the memory address 204 involved in the operation and data representative of the metadata 202 associated with the memory allocation 260 corresponding to the memory address 204. The encoded pointer 210 may include additional information, such as data representative of a tag or version of the memory allocation 260 and pointer arithmetic bits (e.g., mutable plaintext portion 408) to identify the particular address being accessed within the memory allocation. In one or more embodiments, the midpoint of the slot to which the targeted memory allocation is assigned is used to locate metadata (e.g., a tag, a descriptor, right bounds, left bounds, extended right bounds, extended left bounds) in a tag table.

The memory/cache 220 may include any number and/or combination of electrical components, semiconductor devices, optical storage devices, quantum storage devices, molecular storage devices, atomic storage devices, and/or logic elements capable of storing information and/or data. All or a portion of the memory/cache 220 may include transitory memory circuitry, such as RAM, DRAM, SRAM, or similar. All or a portion of the memory/cache 220 may include non-transitory memory circuitry, such as: optical storage media; magnetic storage media; NAND memory; and similar. The memory/cache 220 may include one or more storage devices having any storage capacity. For example, the memory/cache 220 may include one or more storage devices having a storage capacity of about: 512 kilobytes or greater; 1 megabyte (MB) or greater; 100 MB or greater; 1 gigabyte (GB) or greater; 100 GB or greater; 1 terabyte (TB) or greater; or about 100 TB or greater.

In the shown embodiment of FIG. 2, the IMC 234 apportions the memory/cache 220 into any power of two number of slots 240. In some embodiments, the IMC 234 may apportion the memory/cache 220 into a single memory slot 240 (i.e., a power of two=2^{m}, for a value of m that results in the entire system memory being covered). In other embodiments, the IMC 234 may apportion the memory/cache 220 into two memory slots 240 (i.e., a power of two=2^{m-1}). In other embodiments, the IMC 234 may apportion the memory/cache 220 into four memory slots 240 (i.e., a power of two=2^{m-2}). In other embodiments, the IMC 234 may apportion the memory/cache 220 into “n” memory allocations 240 (i.e., a power of two=2^{k} for a value k that results in dividing the memory space into “n” slots). Importantly, note that the midpoint address 242 in each of the memory slots 240 does not align with the midpoint address in other memory slots, thereby permitting the storage of metadata (in a metadata region 250) that is unique to the respective memory slot 240s. In some embodiments, the metadata may include any number of bits. For example, the metadata may include 2 bits or more, 4-bits or more, 6-bits or more; 8-bits or more, 16-bits or more, or 32-bits or more.

The encoded pointer 210 is created for one of the memory allocations 260 (e.g., 32B allocation, 56B allocation, 48B allocation, 24B allocation, or 64B allocation) and includes memory address 204 for an address within the memory range of that memory allocation. When memory is initially allocated, the memory address may point to the lower bounds of the memory allocation. The memory address may be adjusted during execution of the application 270 using pointer arithmetic to reference a desired memory address within the memory allocation to perform a memory operation (fetch, store, etc.). The memory address 204 may include any number of bits. For example, the memory address 204 may include: 8-bits or more; 16-bits or more, 32-bits or more; 48-bits or more; or 64-bits or more; 128-bits or more; 256-bits or more, 512-bits for more, up to 2 to the power of the linear address width for the current operating mode, e.g., the user linear address width-bits in terms of slot sizes being addressed. In embodiments, the metadata 202 carried by the encoded pointer 210 may include any number of bits. For example, the metadata 202 may include 4-bits or more, 8-bits or more, 16-bits or more, or 32-bits or more. In embodiments, all or a portion of the address and/or tag metadata carried by the encoded pointer 210 may be encrypted.

In embodiments, the contents of metadata regions 250 may be loaded as a cache line (e.g., a 32-byte block, 64-byte block, or 128-byte block, 256-byte block or more, 512-byte block, or a block size equal to a power of two-bytes) into the cache of processor circuitry 230. In performing memory operations on contents of a metadata region stored in the cache of processor circuitry 230, the memory controller circuitry 234 or other logic, e.g., in processor circuitry 230, can decrypt the contents (if the contents were stored in an encrypted form), and take appropriate actions with the contents from the metadata region 250 stored on the cache line containing the requested memory address.

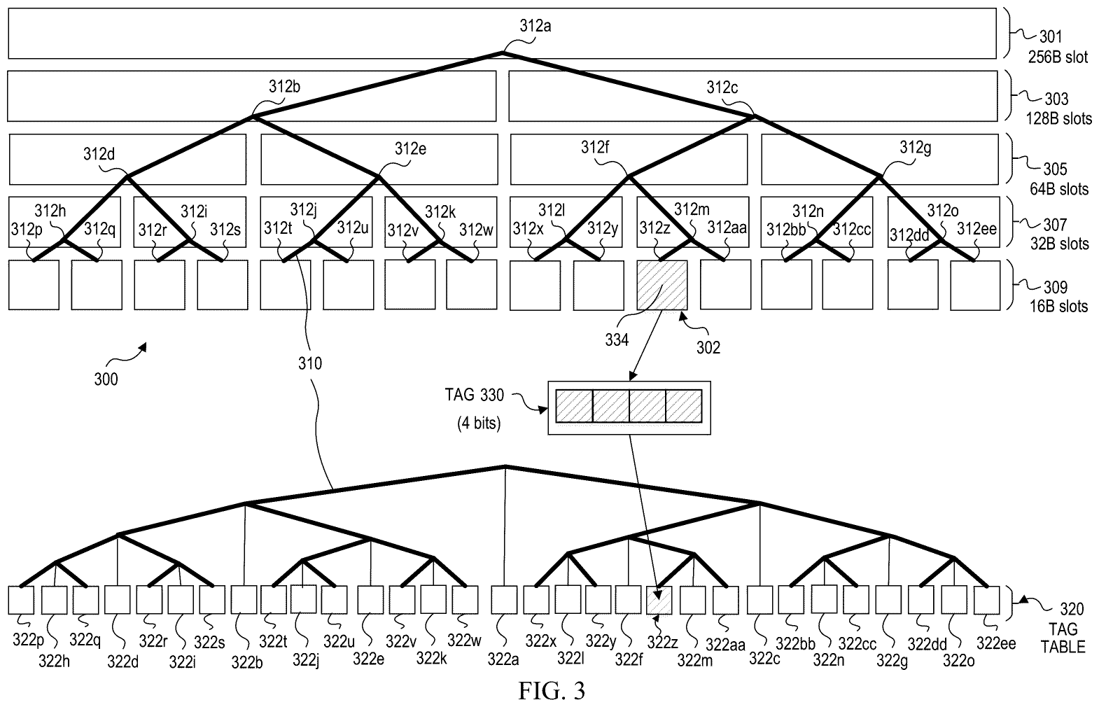

FIG. 3 is a graphical representation of a memory space 300 and the selection of an index of a metadata location in a tag table for a particular memory allocation in the memory space 300. Memory space 300 illustrates memory (e.g., heap) that is conceptually divided into power of two sized slots with a binary tree 310 illustrated thereon. As shown and described herein (e.g., with reference to FIG. 2), non-overlapping memory allocations can be assigned to respective slots. The slot size of the particular slot to which a given memory allocation is assigned can be specified in a Po2 size metadata portion (e.g., 102) of an encoded pointer (e.g., 110) generated for the given memory allocation. The particular slot can be identified based on the Po2 size metadata and the linear address in the encoded pointer of the memory allocation.

FIG. 3 is a graphical representation of a memory space 300 and the selection of an index of a metadata location in a tag table for a particular memory allocation in the memory space 300. Memory space 300 illustrates memory (e.g., heap) that is conceptually divided into overlapping power of two sized slots. For each power of two size, the memory space 300 can be divided into a different number of slots. For example, the memory space can be divided into one 256-byte (256B) slot 301, two 128-byte (128B) slots 303, four 64-byte (64B) slots 305, eight 32-byte (32B) slots 307, and sixteen 16-byte (16B) slots 309.

The midpoints of the slots in memory space 300 form a binary tree 310 illustrated thereon. As shown and described herein (e.g., with reference to FIG. 2), non-overlapping memory allocations can be assigned to respective slots. For example, an allocation 334 in memory space 300 is assigned to a single 16-byte slot 302. The slot size of the particular slot to which a given memory allocation is assigned can be determined based on a Po2 size metadata encoded in size metadata portion (e.g., 102) of an encoded pointer (e.g., 110) generated for the given memory allocation. The location of the slot can be determined based on the Po2 size metadata and the address bits corresponding to the immutable portion (e.g., 106) of an address portion (e.g., 109) of the encoded pointer generated for the memory allocation.

In one embodiment shown in FIG. 3, a tag table 320 can be created to hold a tag for each allocation assigned to a slot in contiguous memory. Depending on the particular architecture, the tag table 320 may be created for different types of contiguous memory. In one architecture, the tag table 320 may be generated to hold a single tag for each allocation assigned to a slot in a contiguous linear address space (e.g., of a program), which is a contiguous range of linear addresses. In this example, the tag table 320 is also linearly contiguous and may be stored in the contiguous linear address space for the program. In another architecture, the tag table 320 may be generated to hold a single tag for each allocation assigned to a slot in contiguous physical memory, which is a contiguous range of physical addresses (e.g., of a program). In this example, the tag table 320 may also be physically contiguous and may be stored in the contiguous physical memory for the program. In yet another architecture, the tag table 320 may be generated to hold a single tag for each page of memory, as the page is physically contiguous. In this example, the tag table 320 may be correspondingly contiguous (e.g., in another page of memory). Generally, the techniques described herein could be applied to any region of memory that is embodied as a contiguous set of memory, in which one tag is set for the entire region.

The binary tree 310 shown on memory space 300 is formed by branches that extend between a midpoint of each (non-leaf) slot and the midpoints of two corresponding child slots. For example, left and right branches from midpoint 312a of a 256-byte slot 301a extend to respective midpoints 312b and 312c of 128-byte slots 303a and 303b that overlap the 256-byte slot 301a. The binary tree 310 can be applied to tag table 320, such that each midpoint of binary tree 310 corresponds to an entry in tag table 320. For example, midpoints 312a-312ee correspond to tag table entries 322a-322ee, respectively.

For the minimum power, corresponding to an allocation 304 fitting within a 16-byte slot, metadata entry 322z in tag table 320 contains 4 bits constituting a tag 330. If the pointer power is, for example zero (0), this can indicate the metadata entry 322z contains just the tag 330. In at least one embodiment, a tag without additional metadata is used for a minimum sized data allocation (e.g., fitting into a 16-byte slot) and is represented as a leaf e.g., 322z in the midpoint binary tree 310 applied to (e.g., superimposed on) tag table 320.

Because every allocation regardless of size can fit into one slot uniquely, for each load and store operation of data or code in an allocation, a single tag can be looked up and compared to the tag metadata encoded in the encoded pointer to the data or code. instead of individual tags for each 16-byte granule (or other designated size of granule).

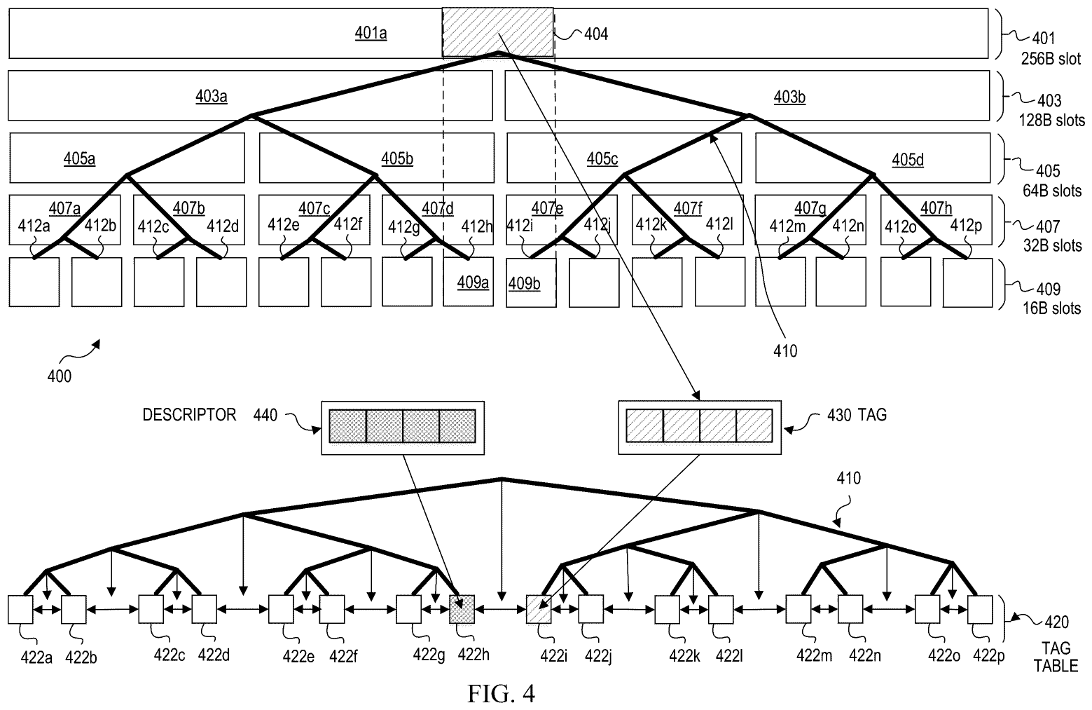

FIG. 4 is a graphical representation of a memory space 400 and the selection of an index of a metadata location in a tag table for a particular memory allocation having a power size for two granules (e.g., 32B) in the memory space 400. Memory space 400 illustrates memory (e.g., heap) that is conceptually divided into overlapping power of two sized slots, as previously described with reference to memory space 300 of FIG. 3. For each power of two size, the memory space 400 can be divided into a different number of slots. For example, the memory space can be divided into one 256-byte (256B) slot 401, two 128-byte (128B) slots 403, four 64-byte (64B) slots 405, eight 32-byte (32B) slots 407, and sixteen 16-byte (16B) slots 409.

The midpoints of the slots in memory space 400 form a binary tree 410 superimposed thereon, which is similar to the binary tree 310 over memory space 300 of FIG. 3. As shown and described herein (e.g., with reference to FIG. 2), non-overlapping memory allocations can be assigned to respective slots. For example, a memory allocation 404 in memory space 400 is assigned to a single 256-byte slot 401a. The slot size of the particular slot to which a given memory allocation is assigned can be determined based on a Po2 size metadata encoded in size metadata portion (e.g., 102) of an encoded pointer (e.g., 110) generated for the given memory allocation. The location of the slot can be determined based on the Po2 size metadata and the address bits corresponding to the immutable portion (e.g., 106) of an address portion (e.g., 109) of the encoded pointer generated for the memory allocation.

In an embodiment shown in FIG. 4, a tag table 420 can be created to hold a tag for each allocation assigned to a slot in contiguous memory. As previously described with reference to tag table 320 of FIG. 3, the techniques described herein can be applied to any region of memory that is embodied as a contiguous set of memory (e.g., linear space, physical memory, memory pages, etc.), in which one tag is set for the entire region.

If an allocation is assigned to a slot with a power size larger than the power size of a single granule (e.g., 16 bytes), at least two adjacent granules of the allocation cross the midpoint of the slot. In FIG. 4 for example, memory allocation 404 is assigned to a slot 401a having a power size for 256 bytes, which is larger than the power size for a single 16-byte granule. Memory allocation 404 includes exactly two granules that cross the midpoint of the slot 401a. The size of memory allocation 404, which contains exactly two granules, is illustrated by dashed lines from the memory allocation to 16-byte slots 409a and 409b.

Because allocations cannot overlap, the two entries in the tag table 420 for each granule adjacent to the midpoint of the larger slot can be merged to represent all slots of two or more granules. Therefore, the tag table 420 only needs to represent the leaf entries and may omit the entries corresponding to midpoints of slots having a power size greater than one granule. For example, entries 422a and 422b can be used in combination to represent an allocation assigned to slot 407a, entries 422b and 422c can be used in combination to represent an allocation assigned to slot 405a, entries 422c and 422d can be used in combination to represent an allocation assigned to slot 407b, entries 422d and 422e can be used in combination to represent an allocation assigned to slot 403a, entries 422e and 422f can be used in combination to represent an allocation assigned to slot 407c, entries 422f and 422g can be used in combination to represent an allocation assigned to slot 405b, entries 422g and 422h can be used in combination to represent an allocation assigned to slot 407d, entries 422h and 422i can be used in combination to represent an allocation assigned to slot 401a, and so on for entries 422i-422p and the remaining slots 403b, 405c, 405d, and 407e-407h. This reduces the table size from N log N to just N, where N corresponds to the number of leaf slots 409.

If the power size is larger than just one granule, then the midpoint slot includes (at a minimum) both adjacent table entries (to the midpoint) of the lowest power by definition as the allocation will always cross the midpoint of the best fitting slot. For the example of memory allocation 404, both entries 422h and 422i adjacent to the midpoint of slot 401a are used where a descriptor 440 is stored in the left entry 422h and a tag 430 is stored in the right entry 422i. The descriptor 440 can describe or indicate the rest of memory allocation 404, which crosses the midpoint of slot 401a. In this example, memory allocation 404 is not larger than two granules so the descriptor can indicate that there are no bounds to the left or right because the allocation is not larger than two granules (e.g., 2×16-byte granules).

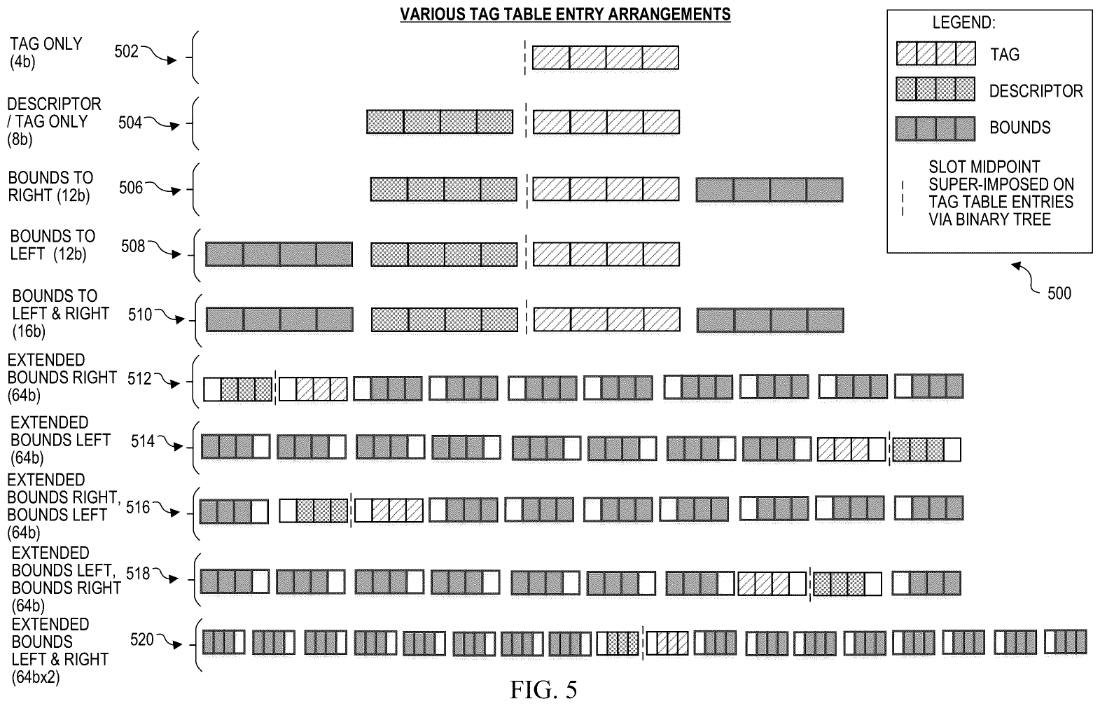

FIG. 5 is a table illustrating possible tag table entry arrangements depending on the size of an allocation. An entry arrangement in a tag table is includes allocation metadata generated for each allocation in a memory space and may be stored in a tag table of the memory space. Allocation metadata can include a tag, a descriptor, one or more right bounds, one or more left bounds, or a suitable combination thereof depending on the size of the allocation. A tag is included in every entry arrangement. A descriptor is included in every entry arrangement corresponding to an allocation that is larger than the smallest granule (e.g., 16 bytes) and, therefore, assigned to a slot having a power size that is greater than the minimum power. For example, in FIG. 4, a descriptor is included in each allocation assigned to a slot in one of the 32-byte slots 407, the 64-byte slots 405, the 128-byte slots 403, or the 256-byte slot 401. Right bounds may be included in a tag table entry arrangement when an allocation extends more than one granule to the right of a midpoint in a slot to which the allocation is assigned. Conversely, left bounds may be included in a tag table entry arrangement when an allocation extends more than one granule to the left of a midpoint in a slot to which the allocation is assigned. Right bounds can include normal right bounds and extended right bounds. Left bounds can include normal left bounds and extended left bounds.

A descriptor defines how additional adjacent entries (if any) in a tag table entry arrangement are interpreted. Because memory may be allocated in various sizes in a program, several descriptor enumerations are possible. In one embodiment, a descriptor for a given allocation may provide one of the following definitions of adjacent table entries corresponding to a particular allocation: 1) for tag table entry arrangement 504, descriptor and tag only represent two granules; 2) for tag table entry arrangement 506, normal bounds to the right, 3) For tag table entry arrangement 508, normal bounds to the left, 4) for tag table entry arrangement 510, normal bounds to the left and the right, 5) for tag table entry arrangement 512, extended bounds to the right (multiple nibbles because it is a large bounds), 6) for tag table entry arrangement 514, extended bounds to the left, 7) for tag table entry arrangement 516, extended bounds to the right, normal bounds to the left, 8) for tag table entry arrangement 518, extended bounds to the left, normal bounds to the right, and 9) for tag table entry arrangement 520, extended bounds to the left and the right.

With reference to the table 500 of FIG. 5, various tag table entry arrangements 502-520 are illustrated. Each of the tag table entry arrangements 502-520 illustrates one or more tag table entries and the contents thereof that collectively represent an allocation having a particular size. For example, a descriptor may not be used for an allocation of the smallest size (e.g., single 16-byte granule), which is assigned to a slot having the minimum power (e.g., zero). A corresponding tag table entry arrangement 502 may include a tag in a tag table entry adjacent to a midpoint of the slot indicated in a binary tree (e.g., 310, 410) of memory space (e.g., 300, 400) applied to the tag table (e.g., 320, 420). Allocation 304 and corresponding tag 330 in tag table 320 is an example of a tag only entry arrangement 502.

An allocation having two granules (e.g., 32 bytes) is assigned to the smallest slot available that can hold the allocation (e.g., slots 401-407 of memory space 400 in FIG. 4). A corresponding tag table entry arrangement 504 includes only a tag and a descriptor in respective tag table entries located on either side of the slot's midpoint indicated in a binary tree applied to the tag table.

It should be noted that bounds are needed in a tag table entry arrangement when the allocation size extends at least one more granule in the left and/or right direction (e.g., 3 granules, 48 bytes for a system with the smallest allocatable granule being 16 bytes). The extension of the allocation size by at least one more granule frees the granule's associated entry in the tag table for use to indicate the bounds. In one embodiment, a 4-bit normal bounds entry may be used. A normal bounds entry may be used to the left and/or to the right of the slot midpoint (e.g., left of the descriptor entry and/or right of the tag entry). Since a 4-bit bounds entry can represent a maximum of 16 granules, the normal left bounds entry can indicate up to 16 bytes to the left of the slot midpoint, and the normal right bounds entry can indicate up to 16 bytes to the right of the slot midpoint.

An allocation having three or more granules but not more than a maximum number of granules within normal bounds, is assigned to the smallest slot available that can hold the allocation (e.g., slots 401-405 of memory space 400 in FIG. 4), and a corresponding tag table entry arrangement can include a left bounds entry, a right bounds entry, or both. In a first scenario, an allocation assigned to a slot has one granule to the left of the slot's midpoint and has two or more granules but less than an extended number of granules to the right of the slot's midpoint. In this scenario, the corresponding tag table entry arrangement 506 can include a tag and a descriptor in respective tag table entries located on either side of the slot's midpoint indicated in a binary tree (e.g., 310, 410) applied to the tag table (e.g., 320, 420). In addition, the tag table entry arrangement 506 can include a right bounds entry adjacent to (e.g., to the right of) the tag. The right bounds entry can indicate how many granules in the allocation extend to the right of the slot's midpoint.

In a second scenario, an allocation assigned to a slot has one granule to the right of the slot's midpoint and has two or more granules but less than an extended number of granules to the left of the slot's midpoint. In this scenario, the corresponding tag table entry arrangement 508 can include a tag and a descriptor in respective tag table entries located on either side of the slot's midpoint indicated in a binary tree (e.g., 310, 410) applied to the tag table (e.g., 320, 420). In addition, the tag table entry arrangement 508 can include a left bounds entry adjacent to (e.g., to the left of) the descriptor. The left bounds entry can indicate how many granules in the allocation extend to the left of the slot's midpoint.

In a third scenario, an allocation assigned to a slot stretches in both directions from the slot midpoint. The allocation has two or more granules to the right of the slot's midpoint and has two or more granules to the left of the slot's midpoint, but less than an extended number of granules in either direction. In this scenario, the corresponding tag table entry arrangement 510 can include a tag and a descriptor in respective tag table entries located on either side of the slot's midpoint indicated in a binary tree (e.g., 310, 410) applied to the tag table (e.g., 320, 420). In addition, the tag table entry arrangement 510 can include a left bounds entry adjacent to (e.g., to the left of) the descriptor. The tag table entry arrangement 510 can also include a right bounds entry adjacent to (e.g., to the right of) the tag. The left bounds entry can indicate how many granules in the allocation extend to the left of the slot's midpoint, and the right bounds entry can indicate how many granules in the allocation extend to the right of the slot's midpoint.

For larger allocations, the extension of an allocation beyond the granules in the normal bounds frees the granules' associated entries in the tag table for use to indicate the extended bounds. Accordingly, freed entries associated with granules in an extended allocation may be used for representing the extended bounds.

By way of example, but not of limitation, for a 4-bit normal bounds entry, a single first extension (also referred to herein as ‘normal bounds’) can only be up to 16 (4 bits)×the smallest granule size. For example, if the smallest granule that can be allocated is 16 bytes, as shown in FIGS. 3 and 4, a single first extension can only be up to 16*16B, which equals 256B. For an extension beyond the first extension (e.g., 256B), extended bounds entries can be included in the tag table entry arrangement corresponding to the allocation. Multiple extended bounds entries in a tag table entry arrangement can be used to define the bounds of the allocation up to the maximum allocation size. A normal bounds entry on the right covers 16 granules to the right. Therefore, for extended bounds to the right, the descriptor can indicate that the bounds metadata to the right includes 64 bits across 16 entries to the right: 16 entries*4 bits/entry, which equals 64 bits. This covers allocations to the right for an entire 64-bit address space. Similarly, for extended bounds to the left, the descriptor can indicate that the bounds metadata to the left includes 64 bits across 16 entries to the left: 16 entries*4 bits/entry, which equals 64 bits. This covers allocations to the left for an entire 64-bit address space.

In a first scenario of an allocation with extended bounds, the allocation is assigned to a slot and has extended bounds to the right of the slot's midpoint and a single granule to the left of the slot's midpoint. In this scenario, the corresponding tag table entry arrangement 512 can include a tag and a descriptor in respective tag table entries located on either side of the slot's midpoint indicated in a binary tree (e.g., 310, 410) applied to the tag table (e.g., 320, 420). Since a 4-bit normal right bounds entry covers 16 granules to the right, the descriptor can indicate that the bounds metadata to the right extend for 64 bits across 16 entries to the right: 16 entries*4 bits/entry, which equals 64 bits. This covers allocations to the right for the entire 64-bit address space. Thus, the tag table entry arrangement 512 can also include sixteen right bounds entries to the right of the tag. The right bounds entries indicate how many granules in the allocation extend to the right of the slot's midpoint.

In a second scenario of an allocation with extended bounds, the allocation is assigned to a slot and has extended bounds to the left of the slot's midpoint and a single granule to the right of the slot's midpoint. In this scenario, the corresponding tag table entry arrangement 514 can include a tag and a descriptor in respective tag table entries located on either side of the slot's midpoint indicated in a binary tree (e.g., 310, 410) applied to the tag table (e.g., 320, 420). Since a 4-bit normal left bounds entry covers 16 granules to the left, the descriptor for extended bounds to the left can indicate that the allocation bounds are extended to the left (e.g., 16 entries*4 bits to cover the entire 64-bit address space). Thus, the tag table entry arrangement 514 can also include sixteen left bounds entries to the left of the descriptor. The left bounds entries indicate how many granules in the allocation extend to the left of the slot's midpoint.

In a third scenario of an allocation with extended bounds, the allocation is assigned to a slot and has extended bounds to the right and left of the slot's midpoint. In this scenario, the corresponding tag table entry arrangement 520 can include a tag and a descriptor in respective tag table entries located on either side of the slot's midpoint indicated in a binary tree (e.g., 310, 410) applied to the tag table (e.g., 320, 420). Since a 4-bit normal right or left bounds entry covers 16 granules to the left, the descriptor for extended bounds to the right and left can indicate that the allocation bounds are extended to the right and left (e.g., 16 entries*4 bits on both the left and right of the slot's midpoint to cover the entire 64-bit address space for the right extension and for the left extension). Thus, the tag table entry arrangement 520 can also include sixteen left bounds entries to the left of the descriptor and sixteen right bounds entries to the right of the tag. The left bounds entries indicate how many granules in the allocation extend to the left of the slot's midpoint. The right bounds entries indicate how many granules in the allocation extend to the right of the slot's midpoint.

In further scenarios, an allocation assigned to a slot may include normal bounds on one side of the slot's midpoint and extended bounds on the other side of the slot's midpoint. In a first scenario of an allocation with mixed bounds, the allocation is assigned to a slot and has extended bounds to the right of the slot's midpoint and normal (not extended) bounds to the left of the slot's midpoint. In this scenario, the corresponding tag table entry arrangement 516 can include a tag and a descriptor in respective tag table entries located on either side of the slot's midpoint indicated in a binary tree (e.g., 310, 410) applied to the tag table. The descriptor in the tag table entry arrangement 516 can indicate that extended right bounds entries (e.g., 64 bits) and a single normal left bounds entry (e.g., 4 bits) correspond to the allocation. The left bounds entries indicate how many granules in the allocation extend (within normal bounds) to the left of the slot's midpoint. The right bounds entries indicate how many granules in the allocation extend to the right of the slot's midpoint (as extended bounds).

In a second scenario of an allocation with mixed bounds, the allocation is assigned to a slot and has extended bounds to the left of the slot's midpoint and normal (not extended) bounds to the right of the slot's midpoint. In this scenario, the corresponding tag table entry arrangement 518 can include a tag and a descriptor in respective tag table entries located on either side of the slot's midpoint indicated in a binary tree (e.g., 310, 410) applied to the tag table. The descriptor in the tag table entry arrangement 518 can indicate that extended left bounds entries (e.g., 64 bits) and a single normal right bounds entry (e.g., 4 bits) correspond to the allocation. The left bounds entries indicate how many granules in the allocation extend to the left of the slot's midpoint (as extended bounds). The right bounds entries indicate how many granules in the allocation extend (within normal bounds) to the right of the slot's midpoint.

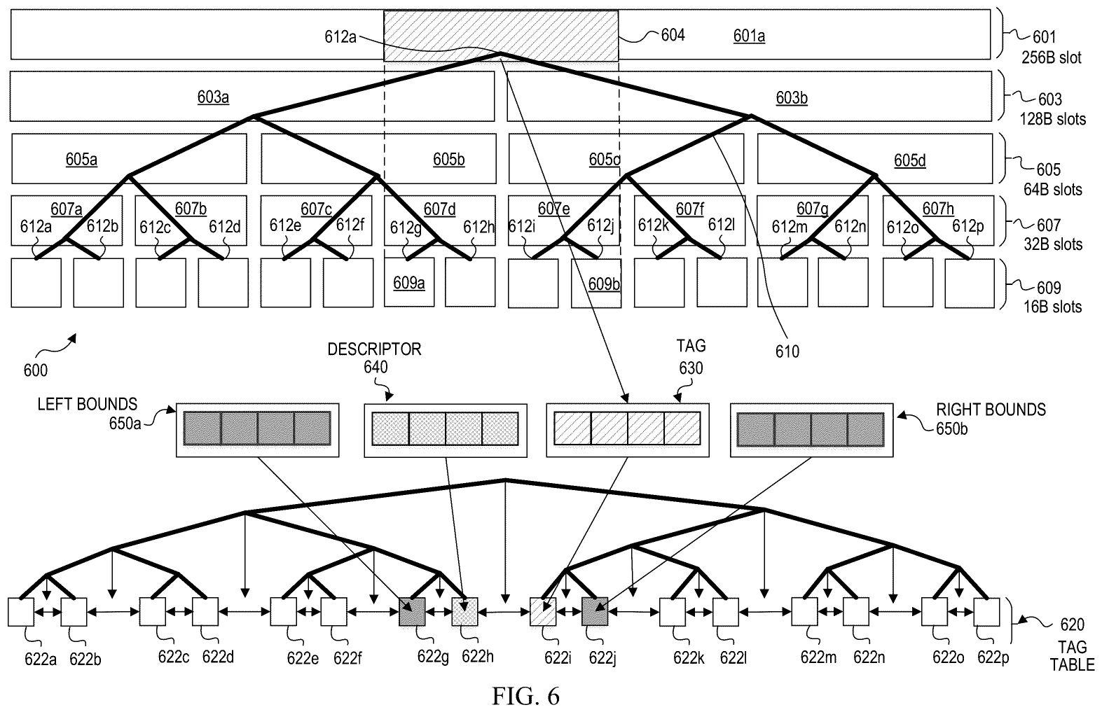

FIG. 6 is a graphical representation of a memory space 600 and the selection of an index of a metadata location in a tag table for a particular memory allocation having a power size that can include at least four granules (e.g., 64B) but not more than a maximum number of granules (e.g., 16 granules or 256B) within normal bounds in the memory space 600. Memory space 600 illustrates memory (e.g., heap) that is conceptually divided into overlapping power of two sized slots, as previously described with reference to memory space 300 of FIG. 3 and memory space 400 of FIG. 4. For each power of two size, the memory space 600 can be divided into a different number of slots. For example, the memory space can be divided into one 256-byte (256B) slot 601, two 128-byte (128B) slots 603, four 64-byte (64B) slots 605, eight 32-byte (32B) slots 607, and sixteen 16-byte (16B) slots 609.

The midpoints of the slots in memory space 600 form a binary tree 610 superimposed thereon, which is similar to the binary tree 310 over memory space 300 of FIG. 3 and binary tree 410 over memory space 400 of FIG. 4. As shown and described herein (e.g., with reference to FIG. 2), non-overlapping memory allocations can be assigned to respective slots. For example, a memory allocation 604 in memory space 600 is assigned to a single 256-byte slot 601a. The slot size of the particular slot to which a given memory allocation is assigned can be determined based on a Po2 size metadata encoded in size metadata portion (e.g., 102) of an encoded pointer (e.g., 110) generated for the given memory allocation. The location of the slot can be determined based on the Po2 size metadata and the address bits corresponding to the immutable portion (e.g., 106) of an address portion (e.g., 109) of the encoded pointer generated for the memory allocation.

In one embodiment shown in FIG. 6, a tag table 620 can be created to hold a tag for each allocation assigned to a slot in contiguous memory. Tag table 620 may have the same or similar configuration as tag table 420 of FIG. 4, where the tag table 420 only needs to represent the leaf entries and may omit entries corresponding to midpoints of slots having a power size greater than one granule. Also, as previously described with reference to tag table 320 of FIG. 3, the techniques described herein can be applied to any region of memory that is embodied as a contiguous set of memory (e.g., linear space, physical memory, memory pages, etc.), in which one tag is set for the entire region.

In FIG. 6, memory allocation 604 is assigned to a slot 601a having a power size for 256 bytes, which is larger than the power size for a single 16-byte granule. Memory allocation 604 includes exactly four granules that cross the midpoint of the slot 601a. The size of memory allocation 604 is illustrated by dashed lines from the allocation to 16-byte slots 609a and 609b. Because the power size for slot 601a is larger than just one granule, the slot 601a includes both adjacent table entries (to the midpoint) of the lowest power by definition as the allocation will always cross the midpoint of the best fitting slot. For memory allocation 604, both entries 622h and 622i adjacent to the midpoint of slot 601a are used as part of a tag table entry arrangement. A descriptor 640 is stored in the left entry 622h and a tag 630 is stored in the right entry 622i. The descriptor 640 can define how additional adjacent entries in tag table 620 are interpreted vis a vis the memory allocation 604. Right bounds information 650b is stored in a third entry 622j to indicate the right bounds of memory allocation 604 (e.g., how many (16B) granules the memory allocation 604 extends to the right of the slot midpoint). Left bounds information 650a is stored in a fourth entry 622g to indicate the left bounds of memory allocation 604 (e.g., how many (16B) granules the allocation 604 extends to the left of the slot midpoint). In this scenario, the number of granules that the memory allocation 604 extends to the left of the slot midpoint is two, and the number of granules that the memory allocation 604 extends to the right of the slot midpoint is two. In other embodiments, the bounds of a memory allocation may be counted in other units such as bytes, for example. Accordingly, the bounds information provides a value that corresponds to the particular unit being counted.

A discussion of memory accesses using embodiments described herein now follows. When a load/store operation for an encoded pointer is beyond the bounds, as measured by the midpoint of the slot determined by the pointer's power and address, an error condition is created. An error condition is also created when the power of two slot does not encompass the bounds. For example, a bound can specify a valid range beyond the slot size. This can occur when a pointer is incremented to the next slot and invalid data is loaded from the table. Zero may be defined as an invalid tag.

Bounds information and tag data for a particular allocation (e.g., bounds information in entries 622g and 622j, descriptor in entry 622h, and tag in entry 622i corresponding to memory allocation 604 in FIG. 6) may be cached at the processor core to avoid additional memory lookups for the same pointer or when pointer arithmetic is performed within the same data allocation. For example, software enumerating a 16-megabyte (MB) array may only require lookup of one tag from the memory tag table that can be cached along with its bounds information for the that same array pointer. This offers significant performance gains over potentially a million additional memory lookups by other memory tagging schemes that use memory tags for every granule (e.g., 16-kilobyte).

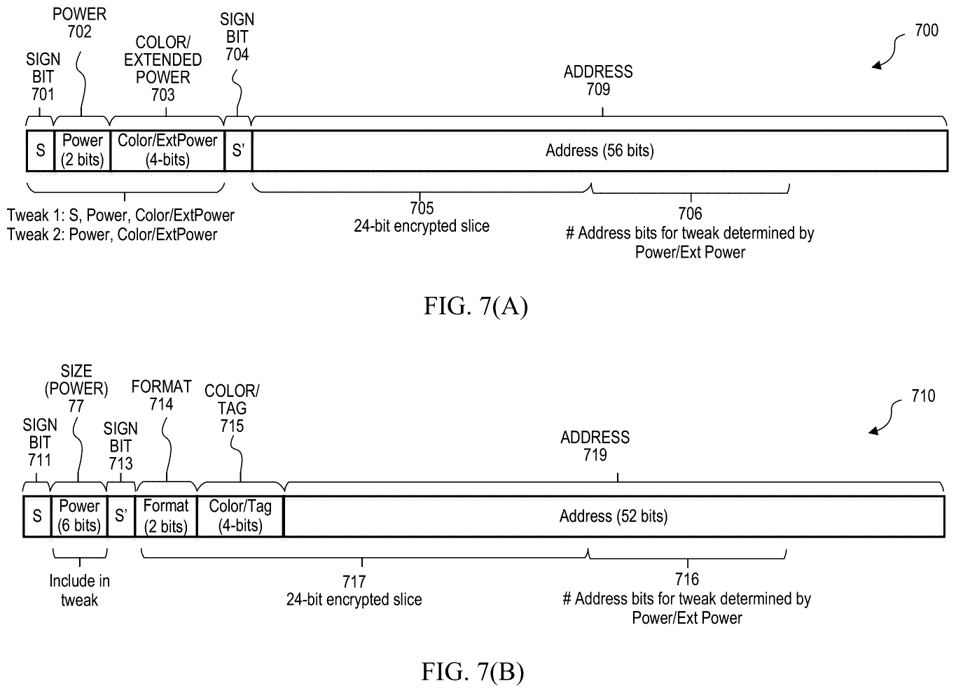

FIG. 7(A) is a schematic diagram of another illustrative encoded pointer architecture according to one embodiment. FIG. 7(A) illustrates an encoded pointer 700 that may be used in one or more embodiments of a memory safety system disclosed herein. The encoded pointer 700 may be configured as any bit size, such as, for example, a 64-bit pointer (as shown in FIG. 7A), a 128-bit pointer, a pointer that is larger than 128-bits (e.g., 256 bits, etc.), or a pointer that is smaller than 64 bits (e.g., 32 bits, 16 bits, etc.). The encoded pointer 700, in one embodiment, may include an x86 architecture pointer.

FIG. 7(A) shows a 64-bit pointer (address) in its base format, using exponent size (power) metadata. The encoded pointer 700 includes a first sign bit field 701, a 2-bit power field 702, a 4-bit color/extended power field 703, a second sign bit field 704, and a multi-bit address field 709. The address field 709 includes a 24-bit encrypted slice 705 and unencrypted address bits 706, which may include an immutable portion and a mutable portion that can be used for pointer arithmetic. The encoded pointer 700 is an example configuration that may be used in one or more embodiments and may be the output of special address encoding logic that is invoked when memory is allocated (e.g., by an operating system, in the heap or in the stack, in the text/code segment) and provided to executing programs in any of a number of different ways, including by using a function such as malloc, alloc, calloc, or new; or implicitly via the loader; or statically allocating memory by the compiler, etc. As a result, an indirect address (e.g., a linear address) that points to the allocated memory, is encoded with metadata (e.g., size/power in power field 702, extended power in color/extended power field 703, and sign bits in sign bit fields 701 and 704) and is partially encrypted (e.g., 705).

Certain operating modes of various architectures may include features that reduce the number of unused bits available for encoding metadata in the pointer. In one example, the Intel® Linear Address Masking (LAM) feature includes a first supervisor mode bit (S) in the first supervisor mode bit field 701. In an embodiment, a supervisor mode bit is set when then processor is executing instructions in supervisor mode and cleared when the processor is executing instructions in user mode. The LAM feature is defined so that canonicality checks are still performed even when some of the unused pointer bits have information embedded in them. A second supervisor mode bit (referred to herein as S′) may also be encoded in a second supervisor mode bit field 704 of encoded pointer 700. The S bit and S′ bit need to match, even though the processor does not require the intervening pointer bits to match. Although embodiments of memory tagging with one memory tag per allocation is not dependent on the LAM feature, some embodiments can work with the fewer unused bits made available in the encoded pointer when LAM is enabled. Encoded pointer 700 illustrates one example of a pointer having fewer available bits. Nevertheless, the particular encoding of encoded pointer 700 enables the pointer to be used in a memory tagging system as described herein.

In at least one embodiment, in encoded pointer 700, an address slice (e.g., upper 24 bits of address field 709) may be encrypted to form a ciphertext portion (e.g., encrypted slice 705) of the encoded pointer 700. In some scenarios, other metadata encoded in the pointer (but not the power 702, extended power 703, or sign bits 701 and 704) may also be encrypted with the address slice that is encrypted. For example, in a 128-bit pointer, additional metadata may be encoded and included in the encrypted slice. The ciphertext portion of the encoded pointer 700 may be encrypted with a small tweakable block cipher (e.g., a SIMON, SPECK, or tweakable K-cipher at a 16-bit block size, 32-bit block size, or other variable bit size tweakable block cipher). Thus, the address slice to be encrypted may use any suitable bit-size block encryption cipher. If the number of ciphertext bits is adjusted (upward or downward), the remaining address bits to be encoded (e.g., immutable and mutable portions) may be adjusted accordingly.

A tweak may be used to encrypt the address slice and may include one or more portions of the encoded pointer 700. For example, one option for a tweak includes the first sign bit field 701 value, the power field 702 value, and the extended power field 703 value. Another option for a tweak includes only the power field 702 value and the extended power field 703 value. In addition, at least some of the unencrypted address bits may also be used in the encryption. In one embodiment, the number of address bits that are to be used in the tweak can be determined by the power field 702 value and the extended power field 703 value.

In one or more embodiments, the different powers encoded in power field 702 correspond to the following:
Power=0: Tag is duplicated for every granule
Power=1: Single tag slot encoding for slot size of 2\hat{ }(7+ExtPower) 128B-4 MiB
Power=2: Single tag slot encoding for slot size of 2\hat{ }(23+ExtPower) 8 MiB-4 GiB ExtPower>9 is reserved
Power=3: Treat as ‘duplicate tag’ encoding to allow selective pass-through of canonical pointers

In all valid encodings, the color field 703 value is checked against a stored color. For powers field 702 values of 1 and 2, the extended power field 703 value is checked against a stored extended power. Adjacent allocations with same power can be assigned different extended power values by an allocator to address adjacent overflow, reused memory can be assigned a different power or extended power to address use after free (UAF) exploits, and other power/extended power assignments can be unpredictable to address non-adjacent overflows and forgeries.

Alternatively, by consuming more pointer bits, an independent color/tag field can be used for any slot size and metadata format, and all pointers up to the maximum slot size can be encrypted, even if the metadata for the allocation is in the duplicated tag format:

FIG. 7(B) is a schematic diagram of another illustrative encoded pointer architecture according to one embodiment. FIG. 7(B) illustrates an encoded pointer 710 that may be used in one or more embodiments of a memory safety system disclosed herein. Encoded pointer 710 is one example alternative to encoded pointer 700 of FIG. 7(A). The encoded pointer 710 may be configured as any bit size, such as, for example, a 64-bit pointer (as shown in FIG. 7A), a 128-bit pointer, a pointer that is larger than 128-bits (e.g., 256 bits, etc.), or a pointer that is smaller than 64 bits (e.g., 32 bits, 16 bits, etc.). The encoded pointer 710, in one embodiment, may include an x86 architecture pointer.

FIG. 7(B) shows a 64-bit pointer (address) in its base format, using exponent size (power) metadata. The encoded pointer 710 includes a first sign bit field 711, a 6-bit size (power) field 712, a second sign bit field 713, a 2-bit format field 714, a 4-bit color/tag field 715, and a 52-bit address field 719. A 24-bit encrypted slice 717 may include an upper portion of the address field 719, the color/tag field 715, and the format field 714. The remaining encrypted address bits may include an immutable portion and a mutable portion that can be used for pointer arithmetic. In at least one embodiment, the number of mutable address bits and immutable address bits may be determined based on the power in size (power) field 712. Like encoded pointer 700, encoded pointer 710 is an example configuration that may be used in one or more embodiments and may be the output of special address encoding logic that is invoked when memory is allocated (e.g., by an operating system, in the heap or in the stack, in the text/code segment) and provided to executing programs in any of a number of different ways, including by using a function such as malloc, alloc, calloc, or new; or implicitly via the loader; or statically allocating memory by the compiler, etc. As a result, an indirect address (e.g., a linear address) that points to the allocated memory, is encoded with metadata (e.g., size/power in size (power) field 712, format in format field 714, color in color/tag field 715, and sign bits in sign bit fields 711 and 713) and is partially encrypted (e.g., 707).

By consuming more pointer bits for metadata in encoded pointer 710, the independent color/tag field 715 can be used for any slot size and metadata format. Additionally, any or all pointers up to the maximum slot size can be encrypted, even if the metadata for the allocation is in the duplicated tag format. The size (power) field 712 value may specify or indicate the number of address bits to include in the pointer encryption tweak. An example of tweak address bits that are determined based on the power in size (power) field 712 is referenced by 716. The format value in format field 714 can specify or indicate the metadata format. An example of possible format values and the corresponding metadata formats is the following:
Format=0: duplicated tags/colors
Format=1: 128-byte slots
Format=2: 256-byte slots
Format=3: 512-byte slots

Most prior memory safety mechanisms suffer from high memory and performance overheads due to excessive metadata, such as duplicated tag values, bounds table entries, or pointers that are doubled in size. Recent proposals have addressed those overheads using slotted pointer formats that efficiently locate non-duplicated metadata or allow legacy-compatible pointer encryption by encoding power of two (Po2) allocation slots into pointers. For example, One Tag (described above) and Linear Inline Metadata (LIM) (as described in “Security Check Systems and Methods for Memory Allocations,” U.S. Pat. No. 11,216,366) store a single metadata item (e.g., bounds and a tag) for each allocation that can be looked up in constant time because the metadata item is at either the midpoint of the containing power-of-two slot (for LIM) or at a corresponding midpoint in a separate metadata table (for One Tag). As another example, Cryptographic Computing (CC) (as described in “Cryptographic Computing Using Encrypted Base Addresses and Used in Multi-tenant Environments”), US Patent Application Publication US-2020-0159676-A1, published May 21, 2020) cryptographically binds pointers to the values of the upper address bits that are constant across an entire allocation. This can in turn be used to uniquely encrypt each allocation and to probabilistically detect overflows beyond the slot boundaries with no added metadata.

However, despite their efficiency benefits, these slotted pointer schemes have not previously offered the ability in all cases to deterministically detect when an access overflows/underflows slot boundaries to the next byte just outside either the upper or lower slot boundary. Software may be able to check surrounding metadata or relevant page mappings to enforce deterministic detection, but that may not always be feasible due to software constraints or the added overhead from performing those checks for each affected allocation.

The technology described below introduces a small amount of redundancy into the pointer (i.e., a copy of relevant address bit(s)), for use in deterministically detecting corruption of those address bit(s).

Previous memory tagging approaches store a duplicate of a tag value for every 16B granule of data. Although memory tagging allows setting different tag values for adjacent allocations, memory tagging suffers from high overheads. Furthermore, memory tagging depends on those tag values for detecting adjacent overflows, whereas the technology described below detects adjacent overflows without requiring any metadata.

Approaches based on capability hardware enhanced reduced instruction set computing instructions (CHERI) architectures double pointer sizes to store bounds within pointers. CHERI stores bounds in pointers, so CHERI deterministically detects both adjacent and non-adjacent allocations. However, CHERI requires substantial changes throughout both hardware and software, and CHERI does not directly enforce temporal safety (e.g., to mitigate use-after-free (UAF)).

In the present approach described below, by duplicating one or more address bits in the pointer that are constant across all pointers to all valid locations within an allocation, the processor can detect corruption of those address bits by comparing the selected address bits and their duplicates when each pointer is dereferenced.

Slotted pointer approaches for efficiently locating memory safety metadata or for encrypting pointers in a manner compatible with legacy software is beneficial for meeting urgent customer requirements for memory safety enforcement. However, detecting adjacent overflows/underflows (i.e., those to the next byte above or below the allocation), can be complicated by pointer slotting due to the possibility of that next byte being in a different slot with intervening allocations in differently sized slots. The technology described below overcomes that complication by allowing a determination to be made based on the pointer value itself whether the pointer is referencing an adjacent slot.

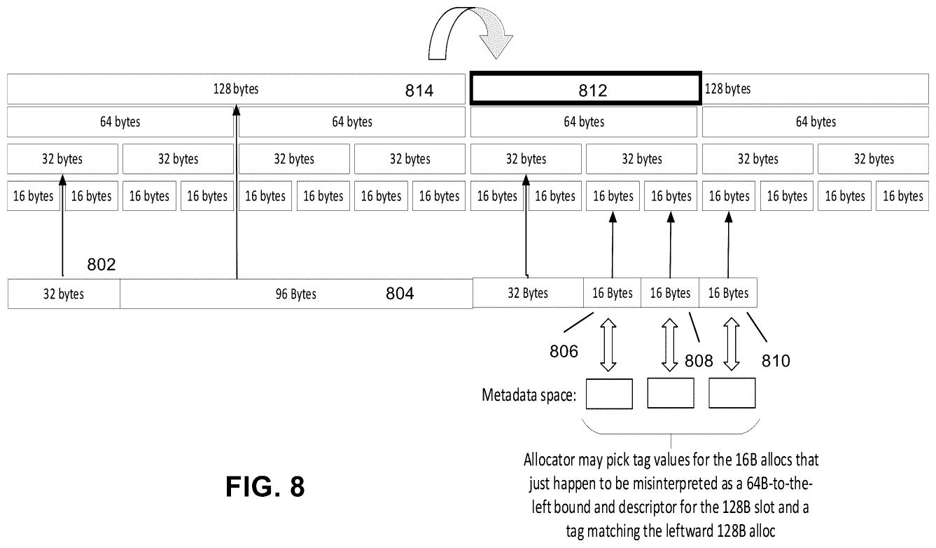

FIG. 8 is a diagram of a potential error scenario 800. This example is based on the One Tag mechanism (described above) for locating non-duplicated metadata in a metadata space that is separate from the data space to avoid disrupting data layout. FIG. 8 shows that even though the 32B allocation 802 sits between the 96B allocation 804 and the series of three 16B allocations 806, 808, and 810, the slot-based metadata lookup results in the metadata for those 16B allocations being misinterpreted as metadata for the adjacent 128B slot 812 to the slot 814 used for the 96B allocation 804. Metadata can be misinterpreted to allow an access to the first byte of that adjacent 128B slot 812 via a pointer derived from the pointer to the 96B allocation 804. An allocator may pick tag values for the 16B allocations 806, 808, and 810 (e.g., allocs) that may be misinterpreted as a 64B to the left bound and descriptor for the 128B slot and a tag matching the leftward 128B allocation 814. The likelihood of whatever metadata, if any, happens to be in the metadata locations for the adjacent slot having the values necessary to permit the adjacent overflow is low. However, it would be advantageous from a security hardening standpoint for the computing system to deterministically detect this type of adjacent overflow/underflow.

The technology described herein provides for deterministically detecting adjacent overflows/underflows outside of slots by duplicating address information that will necessarily be corrupted by such overflows/underflows and placing the duplicated information into a portion of the pointer that is itself immune from such corruption. For example, the software can copy the least-significant slot index bit into the unused pointer bits. The slot index bits are so named, because they effectively indicate the index of the selected slot within the set of all slots for the selected slot size. The slot index bits are never modified by any legitimate pointer arithmetic applied to an allocation that fits within the selected slot; they are only modified by overflows beyond the slot boundaries. Conversely, the offset bits are modified by legitimate pointer arithmetic within the slot.

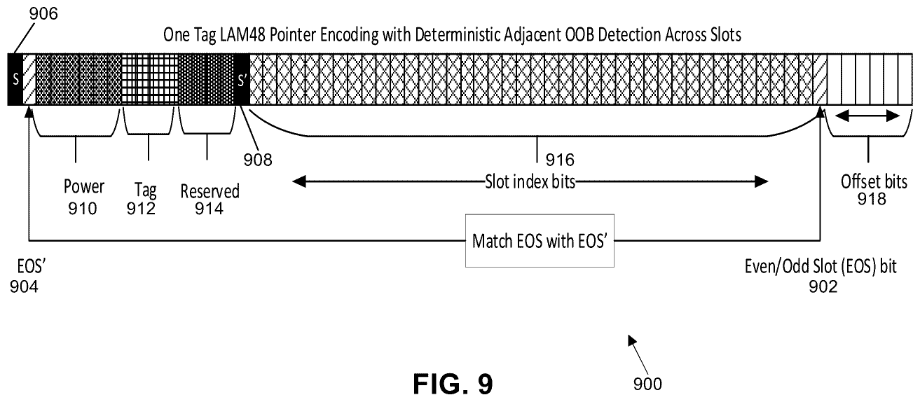

FIG. 9 is a diagram of a one tag 48-bit pointer encoding with deterministic out of bounds (OOB) detection across slots 900 according to an embodiment. The least-significant slot index bit of this linear address masking (LAM) 48-bit example pointer encoding effectively indicates whether the allocation is in an even or odd slot. Hence, that address bit is labeled the Even/Odd Slot bit (EOS) bit 902, and its copy is labeled EOS' 904. When software attempts to use a pointer, the processor will check that EOS 902 and EOS' 904 match. This new type of check is referred to as the “slot polarity check” henceforth. Any adjacent overflow/underflow one byte above/below the end/start of the slot will always flip EOS 902. Supervisor S bit 906 and supervisor S′ bit 908 may also be used for memory safety checking along with the slot polarity check.

In an implementation, the encoded pointer includes a plurality of EOS bits to select additional bits to match in the address field. As shown in FIG. 9, a single EOS bit may be verified (in one embodiment) by comparing the single EOS bit to a copy of the power identified address bit in the reserved address bits. There is no reason to limit that comparison to just one bit, in other implementations two or three or more bits may be compared from the lower address field with a copy of those bits in the upper reserved address field.

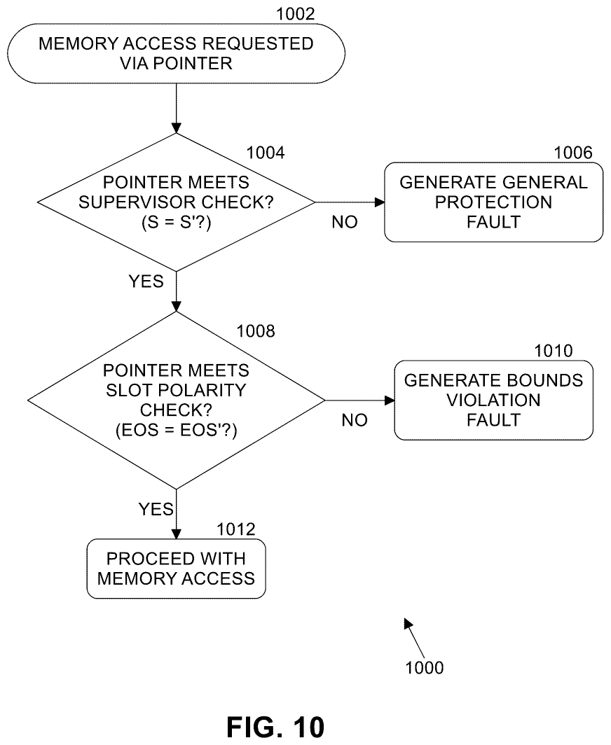

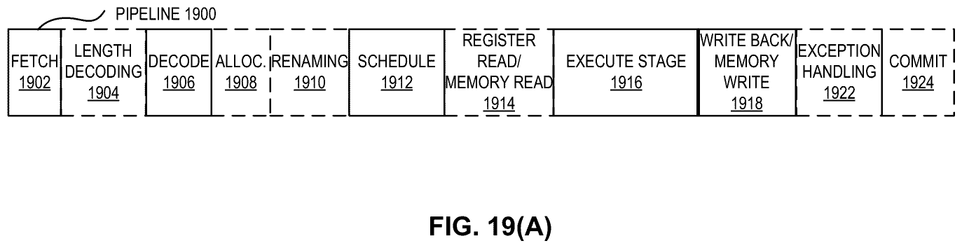

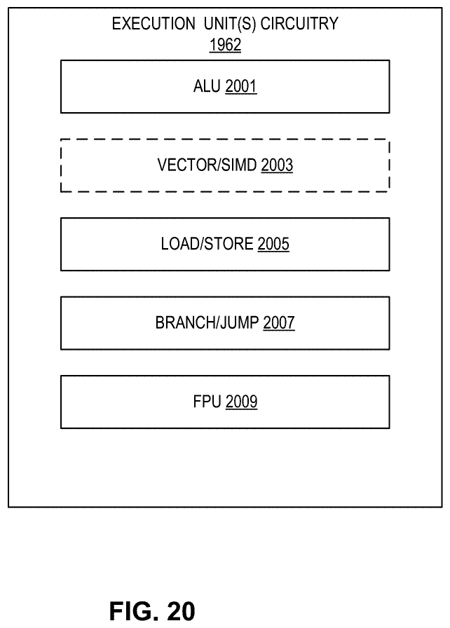

FIG. 10 is a flow diagram of OOB detection processing 1000 according to an embodiment. In an implementation, the operations described in FIG. 10 may be performed by execution engine unit 1950 (which may include a slot polarity check unit circuitry in one example), and/or memory access circuitry 1964 shown in FIG. 19 and a register storing an encoded pointer (e.g., pointing to a memory address to be accessed by a memory access request) may be one of the general-purpose registers 2125 of FIG. 21. In other implementations, the operations of FIG. 10 may be performed in other areas of processor 1770 or 1780, or one or more of cores 1902(A) to 1802(N), for example. A memory access request may include a read operation or a write operation. Expanded memory safety checks, including both the pre-existing canonicality check of the supervisor bits, and the slot polarity check may be implemented by the processor. At block 1002, a memory access is requested via a pointer (in a format such as shown in FIG. 9, for example). At block 1004, the processor performs a supervisor check by comparing (supervisor mode) S bit 906 in the pointer to S′ bit 908 in the pointer. If the S bit 906 does not match the S′ bit 908, then the processor generates a general protection fault at block 1006 and the memory access requested is denied. If the S bit 906 matches the S′ bit 908, then at block 1008 the processor performs a slot polarity check by comparing EOS bit 902 in the pointer to EOS' bit 904 in the pointer. If the EOS bit 902 does not match EOS' bit 904, then an adjacent underflow or adjacent overflow errors will occur if the memory access request is granted and the processor generates a bounds violation fault at block 1010 and the memory access request is denied. If the EOS bit 902 does match EOS' bit 904, then the processor proceeds with the memory access at block 1012.

If a slot spanning the entire address space for the privilege level is supported, e.g., 2\hat{ }47B in this example, then the processor would skip the slot polarity check for that slot size, since there is no EOS bit 902 in that case. The canonicality check could still detect some overflows and underflows, and boundary conditions could be handled as described below.

No adjacent overflow or underflow will ever affect EOS' 904, except in certain boundary conditions. Specifically, one of the boundary conditions is when an overflow occurs from the topmost slot in the upper half of the address space, i.e., kernel space in the typical memory layout. This condition implies that all the address bits are ones. Thus, all the address bits are cleared to zero during the overflow. If the original tag value 912, power value 910, and reserved bits 914 are all ones, the updated values will all be zeroes. This would result in the canonicality check passing, since S 906 and S′ 908 will both be zero, and EOS bit 902 would also match EOS' 904. However, in typical systems, the zero page is left unmapped. Thus, any attempt to access it will result in a page fault, which suffices for detecting the adjacent overflow in this boundary condition despite the canonicality check and slot polarity checks both failing to detect the overflow. If the reserved bits 914 were all zeroes, then the carry-out from the lower pointer bits would detectably corrupt the reserved bits and not affect higher pointer bits. If the reserved bits were all ones, but the original tag value 912 was not all ones, then the carry-out from the lower pointer bits would increment the tag value and not affect higher pointer bits. This would result in the canonicality check triggering an exception. If the original reserved bits 914 and tag value 912 are all ones, but the original power 910 value was not all ones, then the power field would be incremented, but EOS' 904 and S 906 would be unaffected. That would result in the canonicality check triggering an exception. Even if the checks were reordered such that the slot polarity check precedes the canonicality check, the slot polarity check at block 1008 would generate an exception in most cases. Specifically, the updated power 910 value would lead to a different address bit being selected as the EOS bit 902 in most cases. In those cases, the EOS bit 902 value will be zero, which will not match EOS' 904. The other cases are when the new power 910 value is that of untagged memory or a maximally sized slot, both of which lack EOS bits. The canonicality check will still detect the overflow in both of those cases.

The opposite boundary condition occurs when an underflow occurs from the bottommost slot in the lower half of the address space, i.e., user space in the typical memory layout, with tag value 912 and power 910 values of all-zeroes. However, since the bottommost page is unmapped in typical operating systems to detect null pointer dereferences, and hence no allocations would be contained in that page, the bounds on the bottommost allocation will stop at least above that bottommost page. Thus, no allocation will ever extend all the way to that lower boundary, and this boundary condition will not occur.

Other interesting boundary conditions occur when a slot extending to the top of the user address space overflows by a byte and when a slot extending to the bottom of the kernel address space underflows by a byte. In either case, the value of S′ 908 will toggle due to a carry-out from the lower address bits or a carry-in to the lower address bits, and no bits that are more significant than S′ will be affected, including S 906. Thus, S 906 and S′ 908 will be mismatched and will cause canonicality checks to fail if the software attempts to dereference the corrupted pointer.

The EOS' bit 904 could be placed at other locations in the pointer besides the one illustrated above, but that would make the EOS' bit more susceptible to being flipped during an overflow or underflow, the fewer fields are placed between the EOS' bit and the address bits.

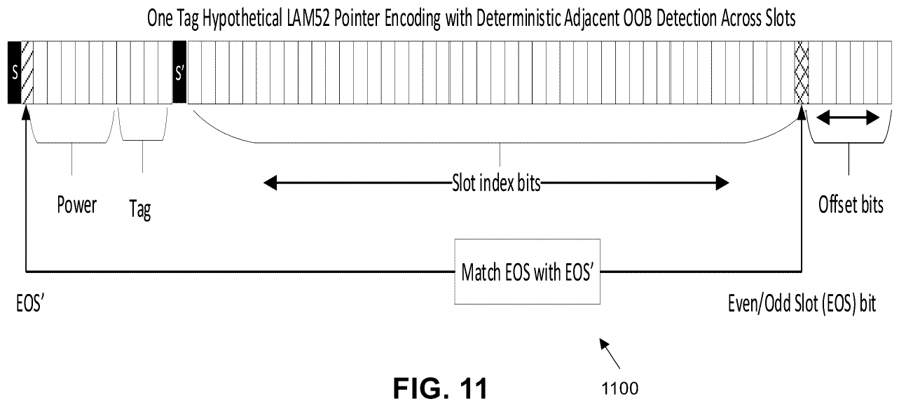

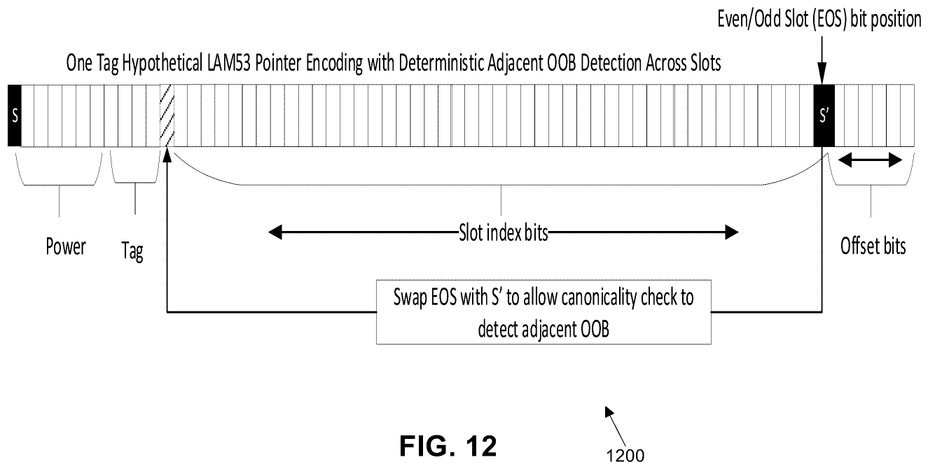

A similar pointer encoding is also possible for five-level paging, although the full 57 address bits do not fit. FIG. 11 is a diagram of a sample one tag 52-address-bit pointer encoding with deterministic OOB detection across slots 1100 according to an embodiment. FIG. 12 is a diagram of a sample one tag 53-address-bit pointer encoding with deterministic OOB detection across slots 1200 according to an embodiment.

The same considerations regarding boundary conditions that were discussed above still apply for this encoding as well.

The addressable address space could be doubled by removing the duplication between the S 906 and S′ 908 bits so that the S′ bit position can be used for an additional address bit. However, this would affect the boundary condition considerations. The considerations for an overflow from the topmost address that wraps around to the bottommost address and vice-versa would mostly be unaffected by the presence of S′ 908, since many of those cases can be detected without relying on the canonicality check of block 1004. However, there were cases that cause the power field to take on a value that results in no EOS bit 902 being defined, i.e., a power value for untagged memory or a power value for a maximally sized slot. The range of valid power values 910 for tagged pointers can be defined such that incrementing or decrementing those values never results in the power value for untagged memory. For example, if the power values of all-zeroes and all-ones are the two values for untagged memory, then the range of power values for tagged pointers may be defined to be 4-52 to represent slot sizes from 16B to 2\hat{ }52B. To avoid an overflow incrementing the power field to that of the maximally sized slot, a discontinuity could be introduced just below the top of the range of valid power values. For example, the range of power values could revised to 4-51, 53, keeping the value 52 reserved so that any pointer with a power value of 52 would trigger an exception when used. The power value 53 would represent a maximal slot size of 2\hat{ }52B in this example.

Furthermore, an overflow from the topmost user space address or an underflow from the bottommost kernel address would be handled differently than in the prior encodings that retain the S′ bit 908.

First consider an overflow from the topmost user space address. If the tag value 912 is all ones, then the carry-out from the address bits through the tag field will increment the power value 910. This may result in a different bit being treated as the EOS bit 902. In this scenario, that is irrelevant, since all the address bits will be zeroed. Since the original slot was odd (i.e., the original EOS 902 value was one), this will result in the slot polarity check triggering an exception unless EOS' 904 is toggled as described next.

If the power value 910 is all ones, then the EOS' bit 904 will be toggled to zero. This will cause the slot polarity check of block 1010 to pass. Furthermore, the S bit 906 will be set to one due to the carry-out from EOS' 904. Thus, the address will reference the bottommost kernel address.

To avoid this outcome, a power value 910 of all-ones can be reserved as invalid for user space addresses. That will cause the power field to “absorb” the carry-out from the tag field in this boundary condition.

Next consider an underflow from the bottommost kernel address. If the tag value 912 is all zeroes, then the carry-in to the address bits through the tag field will decrement the power value 910. This may result in a different bit being treated as the EOS bit 902. In this scenario, that is irrelevant, since all the address bits will be set to one. Since the original slot was even (i.e., the original EOS value 902 was zero), this will result in the slot polarity check triggering an exception unless EOS' 904 is toggled as described next.

If the power field is all zeroes, then the EOS' bit 904 will be toggled to one. This will cause the slot polarity check of block 1010 to pass. Furthermore, the S bit 906 will be set to zero due to the carry-in to EOS' 904. Thus, the address will reference the topmost user space address.

To avoid this outcome, a power value of all-zeroes can be reserved as invalid for kernel addresses. That will cause the power field to “block” the carry-in propagation in this boundary condition.

An alternative encoding that also allows addressing a 53-bit address space per privilege level is to swap the S′ bit 908 and the EOS bit 902 in stored pointers, i.e., in registers and memory. FIG. 12 is a diagram of a sample one tag 53-bit pointer encoding with deterministic OOB detection across slots 1200 according to an embodiment. The bit swap would be reversed prior to canonicality checks and address translation.

Adjacent overflows beyond slot boundaries would flip the repositioned S′ bit 908, thus leading to a canonicality violation without consuming an additional bit nor introducing an additional check. However, this would affect the boundary condition considerations. The considerations for an overflow from the topmost address that wraps around to the bottommost address and vice-versa would be similar to those for the other pointer encodings described previously that retain the S′ bit. Even if it is possible for an overflow to result in the power value 910 being corrupted to a value for untagged pointers or maximally sized slots, the S′ bit will still be considered as part of canonicality checks and will trigger a canonicality violation.

An overflow from the topmost user space address or an underflow from the bottommost kernel address would be handled differently than for the prior encodings.

First consider an overflow from the topmost user space address. The allocation will either be assigned a maximally sized slot, which will result in no EOS bit 902 being defined and the S′ bit 908 being unmoved, or the allocation will be in a non-maximally sized slot with the EOS bit 902 and S′ bit 908 being swapped. In either case, the carry-out from the incremented address bits below the stored position of the S′ bit will cause S′ to be set, and the carry-out will not propagate any further. S′ being set while S remains cleared will cause subsequent canonicality checks on the pointer to fault.

Next consider an underflow from the bottommost kernel address. The same two sub-cases apply in this condition as were described above. For either sub-case, the carry-in needed to decrement the address will be supplied by the S′ bit 908 in its stored position, and no higher pointer bits will be affected. S′ being cleared while S remains set will cause subsequent canonicality checks on the pointer to fault.

The canonical pointer encodings with power value 910 and tag value 912 of all zeroes for user space addresses and all ones for supervisor addresses may be defined as referring to page-sized slots for conveniently covering page-aligned regions that are effectively untagged. The slot concept is only intended to be used for efficiently locating metadata in those cases, and overflows and underflows from one page to the next should be permitted within the untagged regions. Thus, the processor can avoid performing slot parity checks for such pointers. In embodiments that swap S′ 908 and EOS bits 902, the processor can avoid swapping those bits.

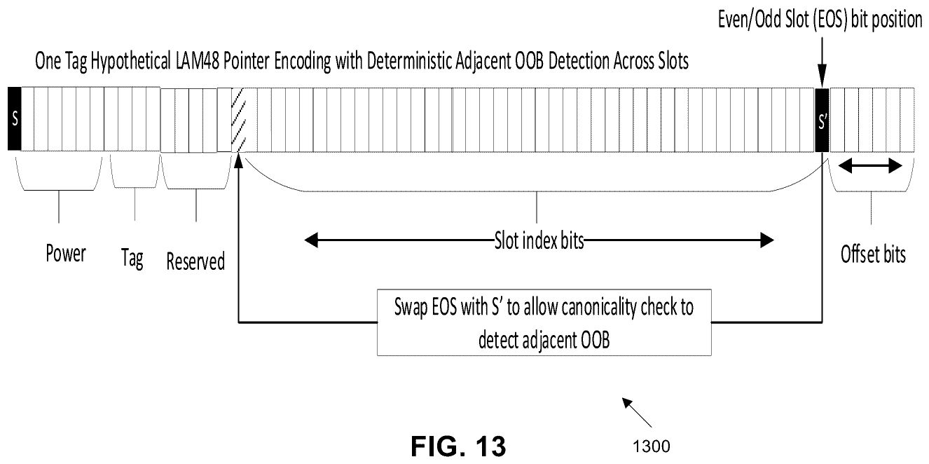

A closely related bit-swapped pointer encoding can be used for LAM48 as well. FIG. 13 is a diagram of another sample one tag 48-bit pointer encoding with deterministic OOB detection across slots 1300 according to an embodiment.

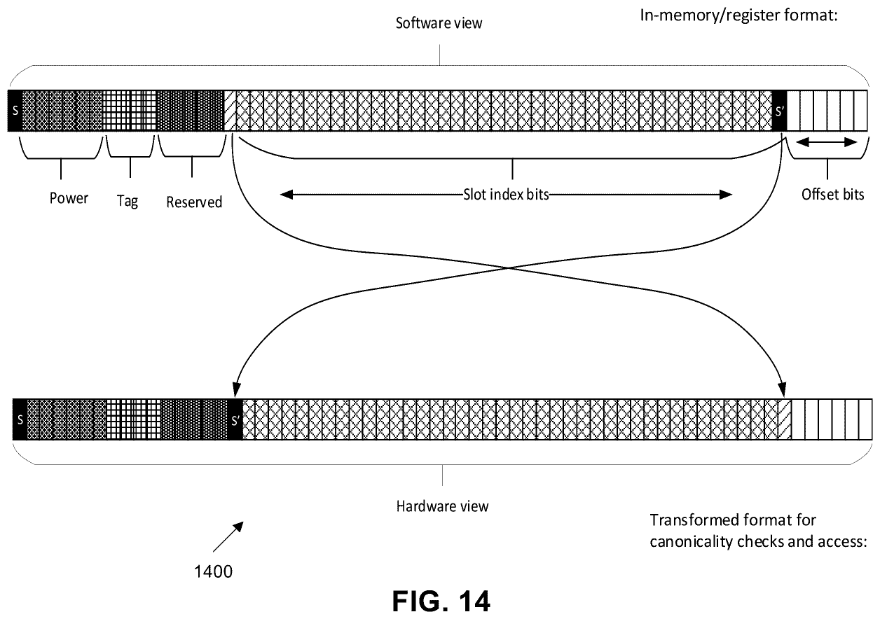

FIG. 14 is a diagram of a software view and a hardware view of a one tag pointer encoding with deterministic OOB detection across slots 1400 according to an embodiment. FIG. 14 shows how the software and the hardware views of the pointer differ.

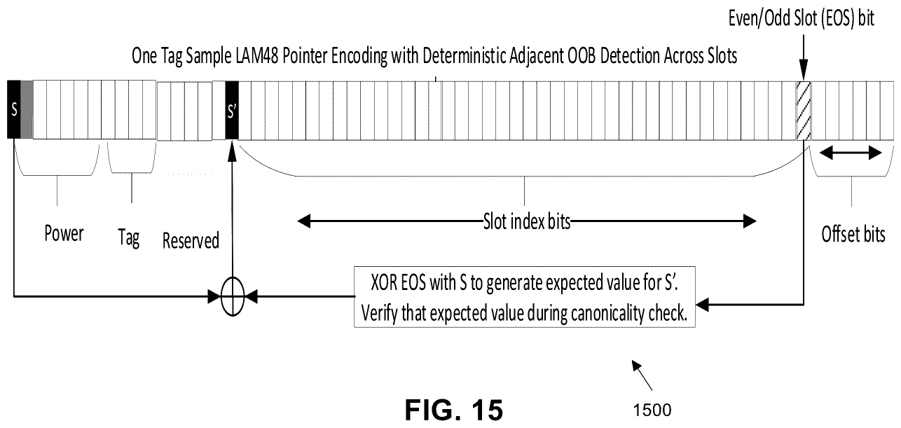

Another variation on these encodings that avoids changing the value of the address bits is shown in FIG. 15. FIG. 15 is a diagram of yet another sample one tag 48-bit pointer encoding with deterministic OOB detection across slots 1500 according to an embodiment.

Being able to rely on the pointer encoding for detecting out-of-slot adjacent overflows/underflows and relying on bounds as provided by One Tag or LIM for detecting intra-slot adjacent overflows/underflows avoids the need to carefully select tags to deterministically detect adjacent overflows/underflows. This may simplify software and avoid overheads that would otherwise be imposed to inspect nearby tag settings when configuring tags for a new allocation.

Checking an EOS bit 902 actually detects more than just adjacent overflows/underflows. It detects Out-Of-Bounds (OOB) accesses anywhere within the adjacent slots. It also detects OOB accesses anywhere within every alternating slot radiating out in both directions starting from the adjacent slots.

This can be extended further by duplicating other address bits such that corruption to any of those bits would be deterministically detected. Those address bits could be contiguous or non-contiguous.

Support for untagged regions with deterministic adjacent OOB checks may be harmonized in the following manner. For canonical (i.e., unencoded) pointers, the processor will assume that page-sized “untagged” slots are in use that are permitted to overflow and underflow into other untagged slots. In other words, the checks for adjacent OOB accesses described above are not desired for such pointers. Thus, the following differences exist in how those pointers are processed compared to other pointers. Do not swap EOS 902 and S′ 908 in untagged pointers. Define a special metadata descriptor value for untagged slots. This avoids page-sized, tagged, slotted pointers from referencing untagged memory and vice-versa.

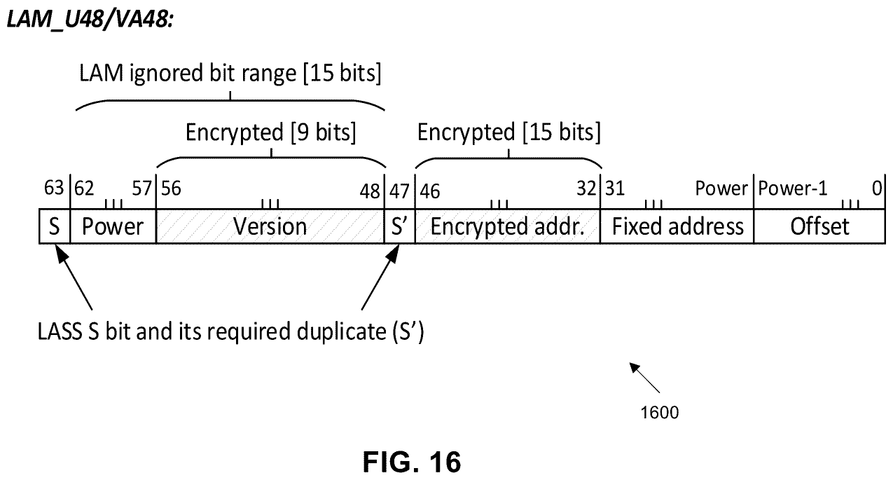

The situation is quite different for adjacent overflows/underflows from Cryptographic Addresses (CAs) in Cryptographic Computing format. However, it may still be advantageous to deterministically detect adjacent overflows/underflows from allocations protected using that mechanism. Specifically, an adjacent overflow/underflow out of a slot in a CA will result in corrupting the value of the fixed and/or encrypted address bits. FIG. 16 is a diagram of a linear address masking (LAM) pointer encoding 1600 according to an embodiment. One difference between the LAM pointer of U.S. Pat. No. 11,403,234 and FIG. 16 is that the encrypted pointer slice in FIG. 16 is split around the S′ bit. That split encrypted pointer slice is still handled as a single cryptographic block, that is, the two parts are merged prior to being encrypted/decrypted and are subsequently separated again with the original S′ bit value being propagated into the output pointer in the same bit position.

When software attempts to use such a corrupted pointer, the encrypted address bits will decrypt incorrectly with high likelihood, which will result in accessing an unintended memory location or generating a page fault due to attempting to reach an inaccessible page. The invalid access will only be detected immediately if the corrupted address happens to land on an inaccessible page mapping. It may be preferable to immediately and deterministically detect adjacent overflows. Analogous EOS bit duplication and checks as described above for unencrypted pointers could also be performed for CAs. EOS' 904 could be encrypted or left unencrypted and incorporated as part of the tweak for the pointer encryption.

Analogously, an authentication code that is computed over an immutable portion of the pointer including EOS' 904 and/or S′ 908 can be inserted in a pointer such that corruption of those input pointer bits will lead to the authentication check detecting the corruption with high probability. Authenticating a pointer consumes pointer bit locations for storing the authentication code, whereas pointer bit encryption can be reversed to allow use of those pointer bit locations for storing address bits, etc. However, authenticating a pointer allows immediate access to the address value without needing to wait for pointer decryption to complete.

For unencrypted, encrypted, and authenticated pointers, additional pointer bits can indicate an adjustment to be performed on the power-of-two slot into which the allocation is fitted. For example, a single adjust bit may be defined that indicates whether the range of the power-of-two slot is offset by half of the size of the power-of-two slot. For example, if the slot size indicated by the power field is 512B, then setting the adjust bit could cause 256B to effectively be added to the starting and ending addresses of the slot. For example, this could be implemented by subtracting 256 from the address in the pointer prior to performing any EOS-based checks and prior to translating the address.

More adjust bits (e.g., EOS bits) may be added to support finer-grained adjustments. For example, two adjust bits would allow adjusting the slots in increments of quarters of slot sizes. A separate field could also be added to allow specifying a number of chunks covering the allocation. For example, if three adjust bits are supported, that effectively divides the slot into eight chunks and allows specifying that the allocation begins at any of those eight possible chunks.

The separate “chunk count” field could specify the number of chunks necessary to cover the allocation. That allows flexibly specifying the bounding box for the allocation, which can lead to a tighter fit to the allocation and detection of a higher proportion of out-of-bounds accesses. This would provide better precision and thus more protection. More details on encoding and checking pointers in this way are described in U.S. Pat. No. 10,860,709 and US Patent Application Publication US-2020-0159676-A1. In an implementation, the encoded pointer includes a plurality of EOS bits to select fractional offsets of the power of two (Po2) size from the power of two starting position.

Exemplary Computer Architectures

Detailed below are descriptions of example computer architectures. Other system designs and configurations known in the arts for laptop, desktop, and handheld personal computers (PCs), personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

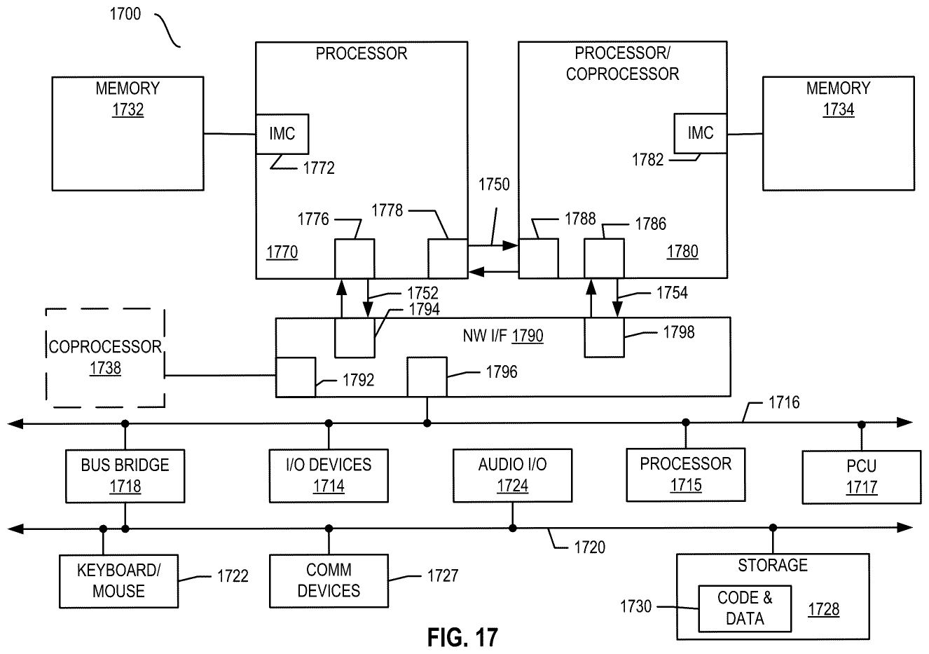

FIG. 17 illustrates an example computing system. Multiprocessor system 1700 is an interfaced system and includes a plurality of processors or cores including a first processor 1770 and a second processor 1780 coupled via an interface 1750 such as a point-to-point (P-P) interconnect, a fabric, and/or bus. In some examples, the first processor 1770 and the second processor 1780 are homogeneous. In some examples, first processor 1770 and the second processor 1780 are heterogenous. Though the example system 1700 is shown to have two processors, the system may have three or more processors, or may be a single processor system. In some examples, the computing system is a SoC.

Processors 1770 and 1780 are shown including integrated memory controller (IMC) circuitry 1772 and 1782, respectively. Processor 1770 also includes interface circuits 1776 and 1778; similarly, second processor 1780 includes interface circuits 1786 and 1788. Processors 1770, 1780 may exchange information via the interface 1750 using interface circuits 1778, 1788. IMCs 1772 and 1782 couple the processors 1770, 1780 to respective memories, namely a memory 1732 and a memory 1734, which may be portions of main memory locally attached to the respective processors.

Processors 1770, 1780 may each exchange information with a network interface (NW I/F) 1790 via individual interfaces 1752, 1754 using interface circuits 1776, 1794, 1786, 1798. The network interface 1790 (e.g., one or more of an interconnect, bus, and/or fabric, and in some examples is a chipset) may optionally exchange information with a coprocessor 1738 via an interface circuit 1792. In some examples, the coprocessor 1738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1770, 1780 or outside of both processors, yet connected with the processors via an interface such as P-P interconnect, such that either or both processors' local cache information may be stored in the shared cache if a processor is placed into a low power mode.

Network interface 1790 may be coupled to a first interface 1716 via an interface circuit 1796. In some examples, first interface 1716 may be an interface such as a Peripheral Component Interconnect (PCI) interconnect, a PCI Express interconnect or another I/O interconnect. In some examples, first interface 1716 is coupled to a power control unit (PCU) 1717, which may include circuitry, software, and/or firmware to perform power management operations with regard to the processors 1770, 1780 and/or co-processor 1738. PCU 1717 provides control information to a voltage regulator (not shown) to cause the voltage regulator to generate the appropriate regulated voltage. PCU 1717 also provides control information to control the operating voltage generated. In various examples, PCU 1717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1717 is illustrated as being present as logic separate from the processor 1770 and/or processor 1780. In other cases, PCU 1717 may execute on a given one or more of cores (not shown) of processor 1770 or 1780. In some cases, PCU 1717 may be implemented as a microcontroller (dedicated or general-purpose) or other control logic configured to execute its own dedicated power management code, sometimes referred to as P-code. In yet other examples, power management operations to be performed by PCU 1717 may be implemented externally to a processor, such as by way of a separate power management integrated circuit (PMIC) or another component external to the processor. In yet other examples, power management operations to be performed by PCU 1717 may be implemented within BIOS or other system software.

Various I/O devices 1714 may be coupled to first interface 1716, along with a bus bridge 1718 which couples first interface 1716 to a second interface 1720. In some examples, one or more additional processor(s) 1715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1716. In some examples, second interface 1720 may be a low pin count (LPC) interface. Various devices may be coupled to second interface 1720 including, for example, a keyboard and/or mouse 1722, communication devices 1727 and storage circuitry 1728. Storage circuitry 1728 may be one or more non-transitory machine-readable storage media as described below, such as a disk drive or other mass storage device which may include instructions/code and data 1730 and may implement the storage ‘ISAB03 in some examples. Further, an audio I/O 1724 may be coupled to second interface 1720. Note that other architectures than the point-to-point architecture described above are possible. For example, instead of the point-to-point architecture, a system such as multiprocessor system 1700 may implement a multi-drop interface or other such architecture.

Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include, on the same die as the described CPU (sometimes referred to as the application core(s) or application processor(s)), the above described coprocessor and additional functionality. Example core architectures are described next, followed by descriptions of example processors and computer architectures.

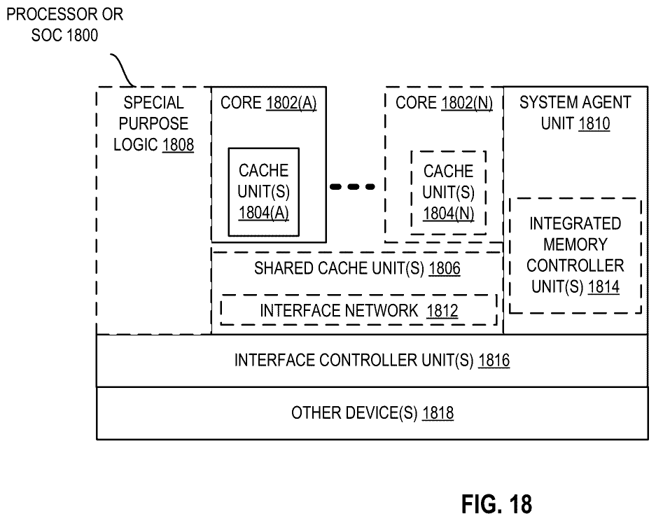

FIG. 18 illustrates a block diagram of an example processor and/or SoC 1800 that may have one or more cores and an integrated memory controller. The solid lined boxes illustrate a processor 1800 with a single core 1802(A), system agent unit circuitry 1810, and a set of one or more interface controller unit(s) circuitry 1816, while the optional addition of the dashed lined boxes illustrates an alternative processor 1800 with multiple cores 1802(A)-(N), a set of one or more integrated memory controller unit(s) circuitry 1814 in the system agent unit circuitry 1810, and special purpose logic 1808, as well as a set of one or more interface controller units circuitry 1816. Note that the processor 1800 may be one of the processors 1770 or 1780, or co-processor 1738 or 1715 of FIG. 17.

Thus, different implementations of the processor 1800 may include: 1) a CPU with the special purpose logic 1808 being integrated graphics and/or scientific (throughput) logic (which may include one or more cores, not shown), and the cores 1802(A)-(N) being one or more general purpose cores (e.g., general purpose in-order cores, general purpose out-of-order cores, or a combination of the two); 2) a coprocessor with the cores 1802(A)-(N) being a large number of special purpose cores intended primarily for graphics and/or scientific (throughput); and 3) a coprocessor with the cores 1802(A)-(N) being a large number of general purpose in-order cores. Thus, the processor 1800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1804(A)-(N) within the cores 1802(A)-(N), a set of one or more shared cache unit(s) circuitry 1806, and external memory (not shown) coupled to the set of integrated memory controller unit(s) circuitry 1814. The set of one or more shared cache unit(s) circuitry 1806 may include one or more mid-level caches, such as level 2 (L2), level 3 (L3), level 4 (L4), or other levels of cache, such as a last level cache (LLC), and/or combinations thereof. While in some examples interface network circuitry 1812 (e.g., a ring interconnect) interfaces the special purpose logic 1808 (e.g., integrated graphics logic), the set of shared cache unit(s) circuitry 1806, and the system agent unit circuitry 1810, alternative examples use any number of well-known techniques for interfacing such units. In some examples, coherency is maintained between one or more of the shared cache unit(s) circuitry 1806 and cores 1802(A)-(N). In some examples, interface controller units circuitry 1816 couple the cores 1802 to one or more other devices 1818 such as one or more I/O devices, storage, one or more communication devices (e.g., wireless networking, wired networking, etc.), etc.

In some examples, one or more of the cores 1802(A)-(N) are capable of multi-threading. The system agent unit circuitry 1810 includes those components coordinating and operating cores 1802(A)-(N). The system agent unit circuitry 1810 may include, for example, power control unit (PCU) circuitry and/or display unit circuitry (not shown). The PCU may be or may include logic and components needed for regulating the power state of the cores 1802(A)-(N) and/or the special purpose logic 1808 (e.g., integrated graphics logic). The display unit circuitry is for driving one or more externally connected displays.

The cores 1802(A)-(N) may be homogenous in terms of instruction set architecture (ISA). Alternatively, the cores 1802(A)-(N) may be heterogeneous in terms of ISA; that is, a subset of the cores 1802(A)-(N) may be capable of executing an ISA, while other cores may be capable of executing only a subset of that ISA or another ISA.

Example Core Architectures—In-Order and Out-of-Order Core Block Diagram.

FIG. 19(A) is a block diagram illustrating both an example in-order pipeline and an example register renaming, out-of-order issue/execution pipeline according to examples. FIG. 19(B) is a block diagram illustrating both an example in-order architecture core and an example register renaming, out-of-order issue/execution architecture core to be included in a processor according to examples. The solid lined boxes in FIGS. 19(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 19(A), a processor pipeline 1900 includes a fetch stage 1902, an optional length decoding stage 1904, a decode stage 1906, an optional allocation (Alloc) stage 1908, an optional renaming stage 1910, a schedule (also known as a dispatch or issue) stage 1912, an optional register read/memory read stage 1914, an execute stage 1916, a write back/memory write stage 1918, an optional exception handling stage 1922, and an optional commit stage 1924. One or more operations can be performed in each of these processor pipeline stages. For example, during the fetch stage 1902, one or more instructions are fetched from instruction memory, and during the decode stage 1906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1906 and the register read/memory read stage 1914 may be combined into one pipeline stage. In one example, during the execute stage 1916, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 19(B) may implement the pipeline 1900 as follows: 1) the instruction fetch circuitry 1938 performs the fetch and length decoding stages 1902 and 1904; 2) the decode circuitry 1940 performs the decode stage 1906; 3) the rename/allocator unit circuitry 1952 performs the allocation stage 1908 and renaming stage 1910; 4) the scheduler(s) circuitry 1956 performs the schedule stage 1912; 5) the physical register file(s) circuitry 1958 and the memory unit circuitry 1970 perform the register read/memory read stage 1914; the execution cluster(s) 1960 perform the execute stage 1916; 6) the memory unit circuitry 1970 and the physical register file(s) circuitry 1958 perform the write back/memory write stage 1918; 7) various circuitry may be involved in the exception handling stage 1922; and 8) the retirement unit circuitry 1954 and the physical register file(s) circuitry 1958 perform the commit stage 1924.

FIG. 19(B) shows a processor core 1990 including front-end unit circuitry 1930 coupled to execution engine unit circuitry 1950, and both are coupled to memory unit circuitry 1970. The core 1990 may be a reduced instruction set architecture computing (RISC) core, a complex instruction set architecture computing (CISC) core, a very long instruction word (VLIW) core, or a hybrid or alternative core type. As yet another option, the core 1990 may be a special-purpose core, such as, for example, a network or communication core, compression engine, coprocessor core, general purpose computing graphics processing unit (GPGPU) core, graphics core, or the like.

The front-end unit circuitry 1930 may include branch prediction circuitry 1932 coupled to instruction cache circuitry 1934, which is coupled to an instruction translation lookaside buffer (TLB) 1936, which is coupled to instruction fetch circuitry 1938, which is coupled to decode circuitry 1940. In one example, the instruction cache circuitry 1934 is included in the memory unit circuitry 1970 rather than the front-end circuitry 1930. The decode circuitry 1940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1940 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1940 may be implemented using various different mechanisms. Examples of suitable mechanisms include, but are not limited to, look-up tables, hardware implementations, programmable logic arrays (PLAs), microcode read only memories (ROMs), etc. In one example, the core 1990 includes a microcode ROM (not shown) or other medium that stores microcode for certain macroinstructions (e.g., in decode circuitry 1940 or otherwise within the front-end circuitry 1930). In one example, the decode circuitry 1940 includes a micro-operation (micro-op) or operation cache (not shown) to hold/cache decoded operations, micro-tags, or micro-operations generated during the decode or other stages of the processor pipeline 1900. The decode circuitry 1940 may be coupled to rename/allocator unit circuitry 1952 in the execution engine circuitry 1950.

The execution engine circuitry 1950 includes the rename/allocator unit circuitry 1952 coupled to retirement unit circuitry 1954 and a set of one or more scheduler(s) circuitry 1956. The scheduler(s) circuitry 1956 represents any number of different schedulers, including reservations stations, central instruction window, etc. In some examples, the scheduler(s) circuitry 1956 can include arithmetic logic unit (ALU) scheduler/scheduling circuitry, ALU queues, address generation unit (AGU) scheduler/scheduling circuitry, AGU queues, etc. The scheduler(s) circuitry 1956 is coupled to the physical register file(s) circuitry 1958. Each of the physical register file(s) circuitry 1958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1958 includes vector registers unit circuitry, writemask registers unit circuitry, and scalar register unit circuitry. These register units may provide architectural vector registers, vector mask registers, general-purpose registers, etc. The physical register file(s) circuitry 1958 is coupled to the retirement unit circuitry 1954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1954 and the physical register file(s) circuitry 1958 are coupled to the execution cluster(s) 1960. The execution cluster(s) 1960 includes a set of one or more execution unit(s) circuitry 1962 and a set of one or more memory access circuitry 1964. The execution unit(s) circuitry 1962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1956, physical register file(s) circuitry 1958, and execution cluster(s) 1960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1964). It should also be understood that where separate pipelines are used, one or more of these pipelines may be out-of-order issue/execution and the rest in-order.

In some examples, the execution engine unit circuitry 1950 may perform load store unit (LSU) address/data pipelining to an Advanced Microcontroller Bus (AMB) interface (not shown), and address phase and writeback, data phase load, store, and branches.

The set of memory access circuitry 1964 is coupled to the memory unit circuitry 1970, which includes data TLB circuitry 1972 coupled to data cache circuitry 1974 coupled to level 2 (L2) cache circuitry 1976. In one example, the memory access circuitry 1964 may include load unit circuitry, store address unit circuitry, and store data unit circuitry, each of which is coupled to the data TLB circuitry 1972 in the memory unit circuitry 1970. The instruction cache circuitry 1934 is further coupled to the level 2 (L2) cache circuitry 1976 in the memory unit circuitry 1970. In one example, the instruction cache 1934 and the data cache 1974 are combined into a single instruction and data cache (not shown) in L2 cache circuitry 1976, level 3 (L3) cache circuitry (not shown), and/or main memory. The L2 cache circuitry 1976 is coupled to one or more other levels of cache and eventually to a main memory.

The core 1990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1990 includes logic to support a packed data instruction set architecture extension (e.g., AVX1, AVX2), thereby allowing the operations used by many multimedia applications to be performed using packed data.

Example Execution Unit(s) Circuitry.

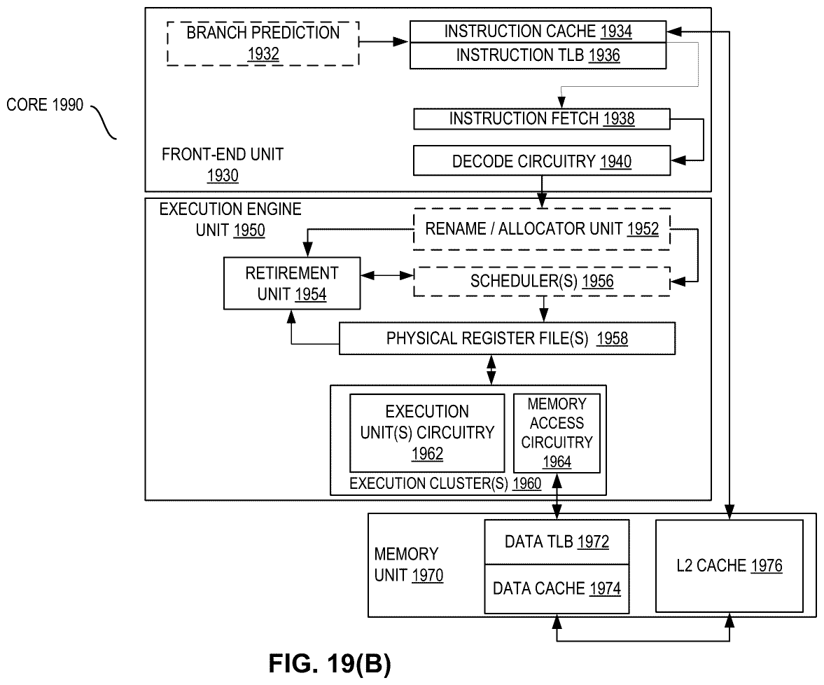

FIG. 20 illustrates examples of execution unit(s) circuitry, such as execution unit(s) circuitry 1962 of FIG. 19(B). As illustrated, execution unit(s) circuitry 1962 may include one or more ALU circuits 2001, optional vector/single instruction multiple data (SIMD) circuits 2003, load/store circuits 2005, branch/jump circuits 2007, and/or Floating-point unit (FPU) circuits 2009. ALU circuits 2001 perform integer arithmetic and/or Boolean operations. Vector/SIMD circuits 2003 perform vector/SIMD operations on packed data (such as SIMD/vector registers). Load/store circuits 2005 execute load and store instructions to load data from memory into registers or store from registers to memory. Load/store circuits 2005 may also generate addresses. Branch/jump circuits 2007 cause a branch or jump to a memory address depending on the instruction. FPU circuits 2009 perform floating-point arithmetic. The width of the execution unit(s) circuitry 1962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Example Register Architecture.

FIG. 21 is a block diagram of a register architecture 2100 according to some examples. As illustrated, the register architecture 2100 includes vector/SIMD registers 2110 that vary from 128-bit to 1,024 bits width. In some examples, the vector/SIMD registers 2110 are physically 512-bits and, depending upon the mapping, only some of the lower bits are used. For example, in some examples, the vector/SIMD registers 2110 are ZMIM registers which are 512 bits: the lower 256 bits are used for YMM registers and the lower 128 bits are used for XMIM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 2100 includes writemask/predicate registers 2115. For example, in some examples, there are 8 writemask/predicate registers (sometimes called k0 through k7) that are each 16-bit, 32-bit, 64-bit, or 128-bit in size. Writemask/predicate registers 2115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 2115 corresponds to a data element position of the destination. In other examples, the writemask/predicate registers 2115 are scalable and consists of a set number of enable bits for a given vector element (e.g., 8 enable bits per 64-bit vector element).

The register architecture 2100 includes a plurality of general-purpose registers 2125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 2100 includes scalar floating-point (FP) register file 2145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 2140 (e.g., EFLAGS, RFLAGS, etc.) store status and control information for arithmetic, compare, and system operations. For example, the one or more flag registers 2140 may store condition code information such as carry, parity, auxiliary carry, zero, sign, and overflow. In some examples, the one or more flag registers 2140 are called program status and control registers.

Segment registers 2120 contain segment points for use in accessing memory. In some examples, these registers are referenced by the names CS, DS, SS, ES, FS, and GS.

Machine specific registers (MSRs) 2135 control and report on processor performance. Most MSRs 2135 handle system-related functions and are not accessible to an application program. Machine check registers 2160 consist of control, status, and error reporting MSRs that are used to detect and report on hardware errors.

One or more instruction pointer register(s) 2130 store an instruction pointer value. Control register(s) 2155 (e.g., CR0-CR4) determine the operating mode of a processor (e.g., processor 1770, 1780, 1738, 1715, and/or 1800) and the characteristics of a currently executing task. Debug registers 2150 control and allow for the monitoring of a processor or core's debugging operations.

Memory (mem) management registers 2165 specify the locations of data structures used in protected mode memory management. These registers may include a global descriptor table register (GDTR), interrupt descriptor table register (IDTR), task register, and a local descriptor table register (LDTR).

Alternative examples may use wider or narrower registers. Additionally, alternative examples may use more, less, or different register files and registers. The register architecture 2100 may, for example, be used in register file/memory ‘ISAB08, or physical register file(s) circuitry 1958.

Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

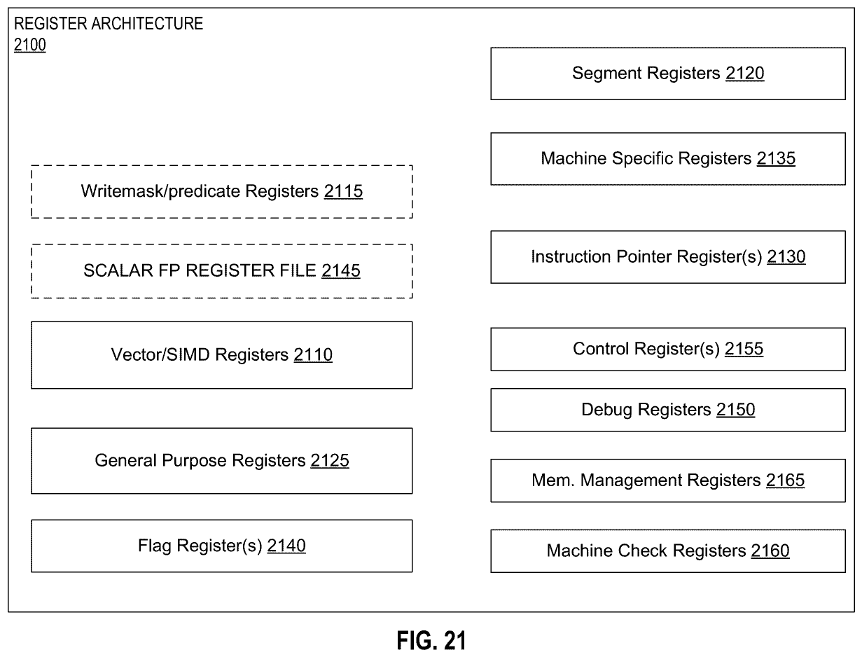

FIG. 22 illustrates examples of an instruction format. As illustrated, an instruction may include multiple components including, but not limited to, one or more fields for: one or more prefixes 2201, an opcode 2203, addressing information 2205 (e.g., register identifiers, memory addressing information, etc.), a displacement value 2207, and/or an immediate value 2209. Note that some instructions utilize some or all of the fields of the format whereas others may only use the field for the opcode 2203. In some examples, the order illustrated is the order in which these fields are to be encoded, however, it should be appreciated that in other examples these fields may be encoded in a different order, combined, etc.

The prefix(es) field(s) 2201, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 2203 is used to at least partially define the operation to be performed upon a decoding of the instruction. In some examples, a primary opcode encoded in the opcode field 2203 is one, two, or three bytes in length. In other examples, a primary opcode can be a different length. An additional 3-bit opcode field is sometimes encoded in another field.

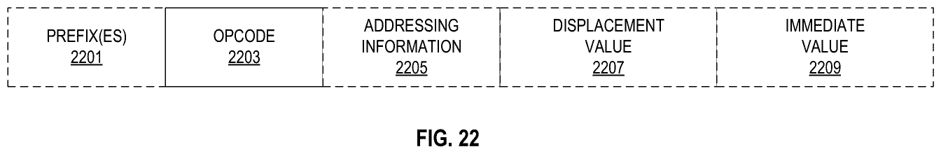

The addressing information field 2205 is used to address one or more operands of the instruction, such as a location in memory or one or more registers. FIG. 23 illustrates examples of the addressing information field 2205. In this illustration, an optional MOD R/M byte 2302 and an optional Scale, Index, Base (SIB) byte 2304 are shown. The MOD R/M byte 2302 and the SIB byte 2304 are used to encode up to two operands of an instruction, each of which is a direct register or effective memory address. Note that each of these fields is optional in that not all instructions include one or more of these fields. The MOD R/M byte 2302 includes a MOD field 2342, a register (reg) field 2344, and R/M field 2346.

The content of the MOD field 2342 distinguishes between memory access and non-memory access modes. In some examples, when the MOD field 2342 has a binary value of 11 (11b), a register-direct addressing mode is utilized, and otherwise a register-indirect addressing mode is used.

The register field 2344 may encode either the destination register operand or a source register operand or may encode an opcode extension and not be used to encode any instruction operand. The content of register field 2344, directly or through address generation, specifies the locations of a source or destination operand (either in a register or in memory). In some examples, the register field 2344 is supplemented with an additional bit from a prefix (e.g., prefix 2201) to allow for greater addressing.

The R/M field 2346 may be used to encode an instruction operand that references a memory address or may be used to encode either the destination register operand or a source register operand. Note the R/M field 2346 may be combined with the MOD field 2342 to dictate an addressing mode in some examples.

The SIB byte 2304 includes a scale field 2352, an index field 2354, and a base field 2356 to be used in the generation of an address. The scale field 2352 indicates a scaling factor. The index field 2354 specifies an index register to use. In some examples, the index field 2354 is supplemented with an additional bit from a prefix (e.g., prefix 2201) to allow for greater addressing. The base field 2356 specifies a base register to use. In some examples, the base field 2356 is supplemented with an additional bit from a prefix (e.g., prefix 2201) to allow for greater addressing. In practice, the content of the scale field 2352 allows for the scaling of the content of the index field 2354 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 2207 provides this value. Additionally, in some examples, a displacement factor usage is encoded in the MOD field of the addressing information field 2205 that indicates a compressed displacement scheme for which a displacement value is calculated and stored in the displacement field 2207.

In some examples, the immediate value field 2209 specifies an immediate value for the instruction. An immediate value may be encoded as a 1-byte value, a 2-byte value, a 4-byte value, etc.

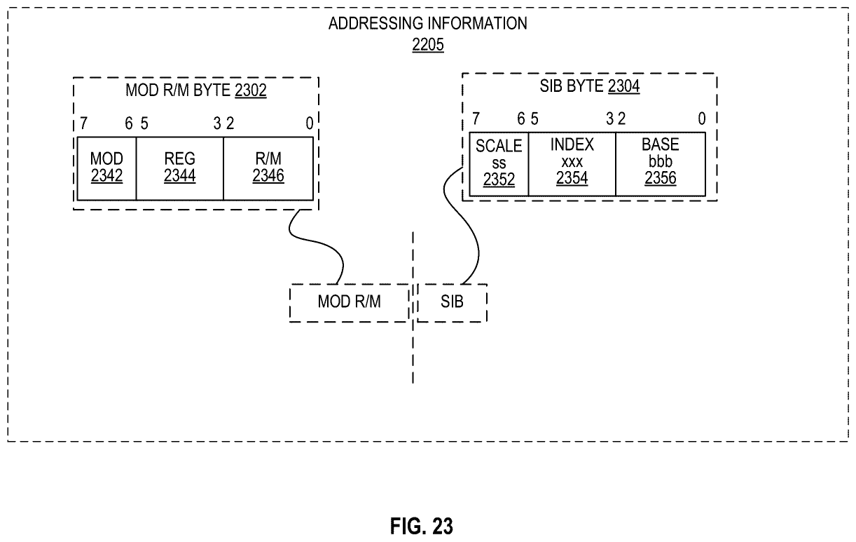

FIG. 24 illustrates examples of a first prefix 2201(A). In some examples, the first prefix 2201(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 2201(A) may specify up to three registers using 3-bit fields depending on the format: 1) using the reg field 2344 and the R/M field 2346 of the MOD R/M byte 2302; 2) using the MOD R/M byte 2302 with the SIB byte 2304 including using the reg field 2344 and the base field 2356 and index field 2354; or 3) using the register field of an opcode.

In the first prefix 2201(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 2344 and MOD R/M R/M field 2346 alone can each only address 8 registers.

In the first prefix 2201(A), bit position 2 (R) may be an extension of the MOD R/M reg field 2344 and may be used to modify the MOD R/M reg field 2344 when that field encodes a general-purpose register, a 64-bit packed data register (e.g., a SSE register), or a control or debug register. R is ignored when MOD R/M byte 2302 specifies other registers or defines an extended opcode.

Bit position 1 (X) may modify the SIB byte index field 2354.

Bit position 0 (B) may modify the base in the MOD R/M R/M field 2346 or the SIB byte base field 2356; or it may modify the opcode register field used for accessing general purpose registers (e.g., general purpose registers 2125).

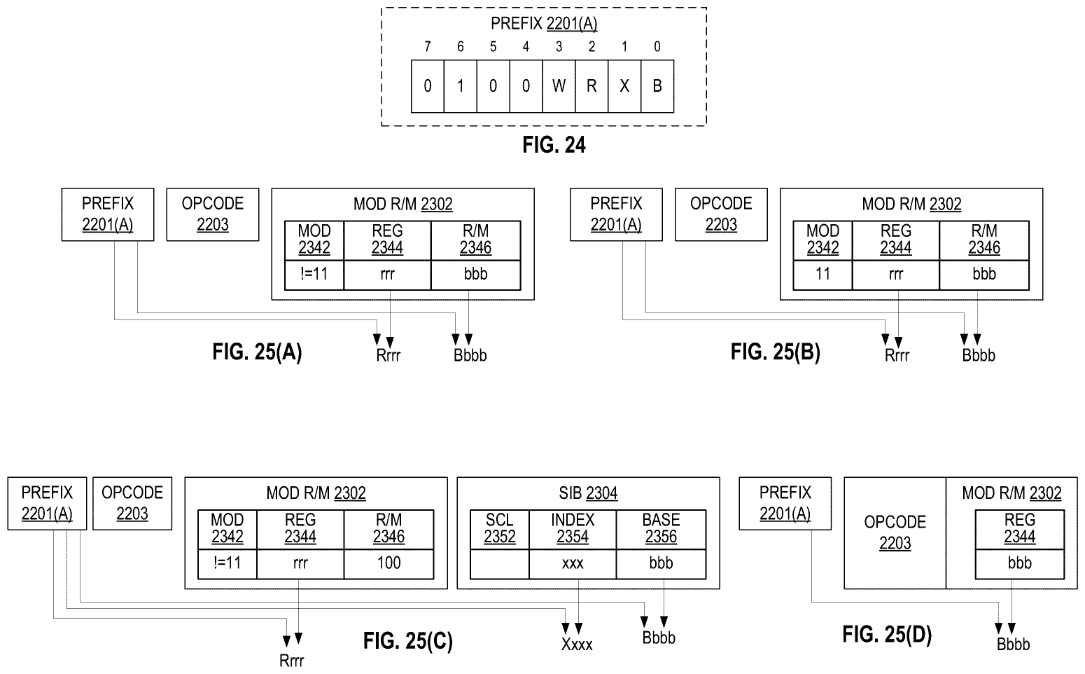

FIGS. 25(A)-(D) illustrate examples of how the R, X, and B fields of the first prefix 2201(A) are used. FIG. 25(A) illustrates R and B from the first prefix 2201(A) being used to extend the reg field 2344 and R/M field 2346 of the MOD R/M byte 2302 when the SIB byte 2304 is not used for memory addressing. FIG. 25(B) illustrates R and B from the first prefix 2201(A) being used to extend the reg field 2344 and R/M field 2346 of the MOD R/M byte 2302 when the SIB byte 2304 is not used (register-register addressing). FIG. 25(C) illustrates R, X, and B from the first prefix 2201(A) being used to extend the reg field 2344 of the MOD R/M byte 2302 and the index field 2354 and base field 2356 when the SIB byte 2304 being used for memory addressing. FIG. 25(D) illustrates B from the first prefix 2201(A) being used to extend the reg field 2344 of the MOD R/M byte 2302 when a register is encoded in the opcode 2203.

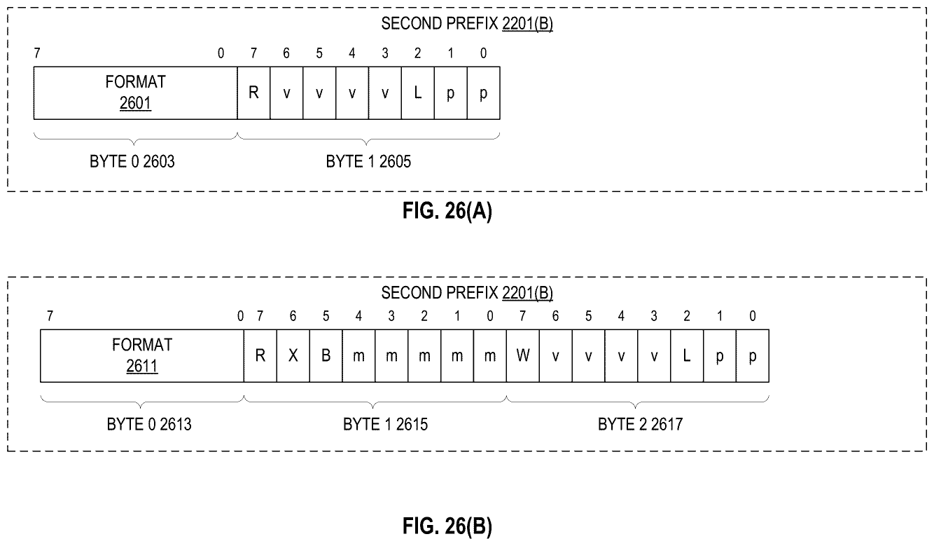

FIGS. 26(A)-(B) illustrate examples of a second prefix 2201(B). In some examples, the second prefix 2201(B) is an example of a VEX prefix. The second prefix 2201(B) encoding allows instructions to have more than two operands, and allows SIMD vector registers (e.g., vector/SIMD registers 2110) to be longer than 64-bits (e.g., 128-bit and 256-bit). The use of the second prefix 2201(B) provides for three-operand (or more) syntax. For example, previous two-operand instructions performed operations such as A=A+B, which overwrites a source operand. The use of the second prefix 2201(B) enables operands to perform nondestructive operations such as A=B+C.

In some examples, the second prefix 2201(B) comes in two forms—a two-byte form and a three-byte form. The two-byte second prefix 2201(B) is used mainly for 128-bit, scalar, and some 256-bit instructions; while the three-byte second prefix 2201(B) provides a compact replacement of the first prefix 2201(A) and 3-byte opcode instructions.

FIG. 26(A) illustrates examples of a two-byte form of the second prefix 2201(B). In one example, a format field 2601 (byte 0 2603) contains the value CSH. In one example, byte 1 2605 includes an “R” value in bit[7]. This value is the complement of the “R” value of the first prefix 2201(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1 s complement) form and valid for instructions with 2 or more source operands; 2) encode the destination register operand, specified in 1 s complement form for certain vector shifts; or 3) not encode any operand, the field is reserved and should contain a certain value, such as 1111b.

Instructions that use this prefix may use the MOD R/M R/M field 2346 to encode the instruction operand that references a memory address or encode either the destination register operand or a source register operand.

Instructions that use this prefix may use the MOD R/M reg field 2344 to encode either the destination register operand or a source register operand, or to be treated as an opcode extension and not used to encode any instruction operand.

For instruction syntax that support four operands, vvvv, the MOD R/M R/M field 2346 and the MOD R/M reg field 2344 encode three of the four operands. Bits[7:4] of the immediate value field 2209 are then used to encode the third source register operand.

FIG. 26(B) illustrates examples of a three-byte form of the second prefix 2201(B). In one example, a format field 2611 (byte 0 2613) contains the value C4H. Byte 1 2615 includes in bits[7:5] “R,” “X,” and “B” which are the complements of the same values of the first prefix 2201(A). Bits[4:0] of byte 1 2615 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 2617 is used similar to W of the first prefix 2201(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1 s complement) form and valid for instructions with 2 or more source operands; 2) encode the destination register operand, specified in 1 s complement form for certain vector shifts; or 3) not encode any operand, the field is reserved and should contain a certain value, such as 1111b.

Instructions that use this prefix may use the MOD R/M R/M field 2346 to encode the instruction operand that references a memory address or encode either the destination register operand or a source register operand.

Instructions that use this prefix may use the MOD R/M reg field 2344 to encode either the destination register operand or a source register operand, or to be treated as an opcode extension and not used to encode any instruction operand.

For instruction syntax that support four operands, vvvv, the MOD R/M R/M field 2346, and the MOD R/M reg field 2344 encode three of the four operands. Bits[7:4] of the immediate value field 2209 are then used to encode the third source register operand.

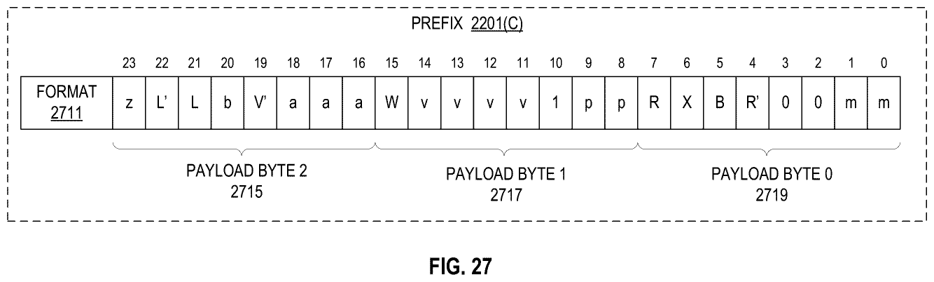

FIG. 27 illustrates examples of a third prefix 2201(C). In some examples, the third prefix 2201(C) is an example of an EVEX prefix. The third prefix 2201(C) is a four-byte prefix.

The third prefix 2201(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 21) or predication utilize this prefix. Opmask register allow for conditional processing or selection control. Opmask instructions, whose source/destination operands are opmask registers and treat the content of an opmask register as a single value, are encoded using the second prefix 2201(B).

The third prefix 2201(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 2201(C) is a format field 2711 that has a value, in one example, of 62H. Subsequent bytes are referred to as payload bytes 2715-2719 and collectively form a 24-bit value of P[23:0] providing specific capability in the form of one or more fields (detailed herein).

In some examples, P[1:0] of payload byte 2719 are identical to the low two mm bits. P[3:2] are reserved in some examples. Bit P[4] (R′) allows access to the high 16 vector register set when combined with P[7] and the MOD R/M reg field 2344. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 2344 and MOD R/M R/M field 2346. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1 s complement) form and valid for instructions with 2 or more source operands; 2) encode the destination register operand, specified in 1 s complement form for certain vector shifts; or 3) not encode any operand, the field is reserved and should contain a certain value, such as 1111b.

P[15] is similar to W of the first prefix 2201(A) and second prefix 2211(B) and may serve as an opcode extension bit or operand size promotion.

P[18:16] specify the index of a register in the opmask (writemask) registers (e.g., writemask/predicate registers 2115). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Examples of encoding of registers in instructions using the third prefix 2201(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Desitination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

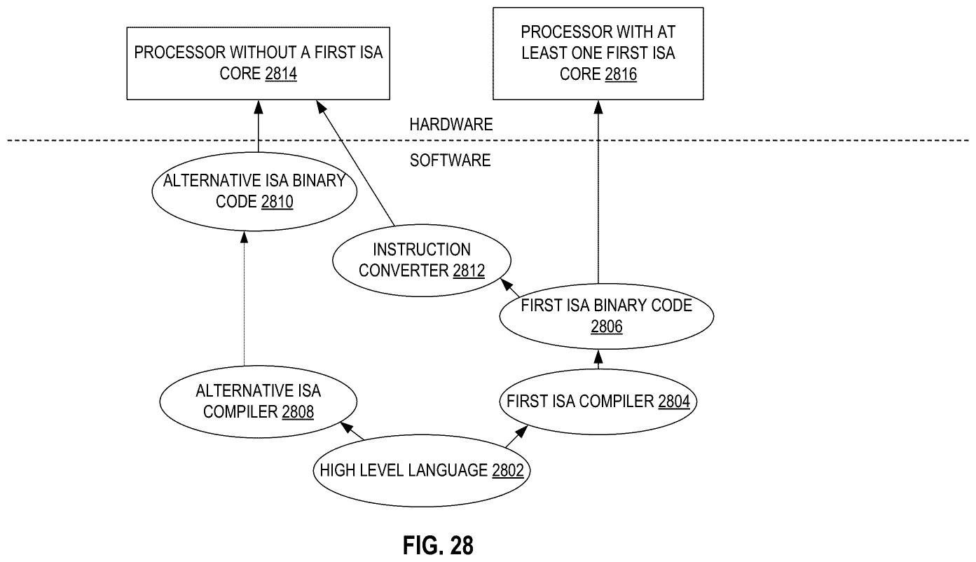

FIG. 28 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 28 shows a program in a high-level language 2802 may be compiled using a first ISA compiler 2804 to generate first ISA binary code 2806 that may be natively executed by a processor with at least one first ISA core 2816. The processor with at least one first ISA core 2816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2804 represents a compiler that is operable to generate first ISA binary code 2806 (e.g., object code) that can, with or without additional linkage processing, be executed on the processor with at least one first ISA core 2816. Similarly, FIG. 28 shows the program in the high-level language 2802 may be compiled using an alternative ISA compiler 2808 to generate alternative ISA binary code 2810 that may be natively executed by a processor without a first ISA core 2814. The instruction converter 2812 is used to convert the first ISA binary code 2806 into code that may be natively executed by the processor without a first ISA core 2814. This converted code is not necessarily to be the same as the alternative ISA binary code 2810; however, the converted code will accomplish the general operation and be made up of instructions from the alternative ISA. Thus, the instruction converter 2812 represents software, firmware, hardware, or a combination thereof that, through emulation, simulation or any other process, allows a processor or other electronic device that does not have a first ISA processor or core to execute the first ISA binary code 2806.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

### EXAMPLES

Example 1 is a processor, including a processing core including a register to store an encoded pointer for a memory address to a memory allocation of a memory, the encoded pointer including a first even odd slot (EOS) bit set to a first value and a second EOS bit set to a second value; and circuitry to receive a memory access request based on the encoded pointer; and in response to determining that the first value matches the second value, perform a memory operation corresponding to the memory access request. In Example 2, the subject matter of Example 1 may optionally include the circuitry to generate a bounds violation fault in response to determining that the first value does not match the second value. In Example 3, the subject matter of Example 1 may optionally include wherein the first EOS bit indicates whether the memory allocation is in an even slot of the memory or an odd slot of the memory. In Example 4, the subject matter of Example 1 may optionally include the encoded pointer including a first supervisor bit set to a third value and a second supervisor bit set to a fourth value and comprising the circuitry to generate a general protection fault in response to determining that the third value does not match the fourth value. In Example 5, the subject matter of Example 1 may optionally include wherein the encoded pointer comprises a slotted memory pointer and the first EOS bit comprises a least significant slot index bit of a plurality of slot index bits.

In Example 6, the subject matter of Example 5 may optionally include wherein the plurality of slot index bits indicates an index of a selected slot within a set of all slots for a selected slot size. In example 7, the subject matter of Example 1 may optionally include wherein the circuitry is to copy the first EOS bit to the second EOS bit, the second EOS bit being a previously unused bit of the encoded pointer. In Example 8, the subject matter of Example 1 may optionally include wherein the encoded pointer comprises a slotted memory pointer and wherein the circuitry is to deterministically detect that a memory access of the memory operation at least one of underflows and overflows a slot boundary to an adjacent byte outside of a slot associated with the encoded pointer. In Example 9, the subject matter of Example 1 may optionally include the circuitry to duplicate at least one address bit in the encoded pointer that is constant across all encoded pointers to all valid locations within an allocation of memory as the first EOS bit. In Example 10, the subject matter of Example 1 may optionally include the circuitry to compare the first value to the second value when the encoded pointer is dereferenced. In Example 11, the subject matter of Example 1 may optionally include wherein at least one of an underflow and an overflow, resulting from the memory operation, into an adjacent byte of a slot flips the first EOS bit. In Example 12, the subject matter of Example 1 may optionally include the circuitry to compare the first value to the second value to detect an out-of-bounds (00B) memory access in adjacent slots of memory when the first value does not match the second value. In Example 13, the subject matter of claim 1 may optionally include wherein the encoded pointer includes a plurality of EOS bits to select fractional offsets of a power of two size from a power of two starting position.

Example 14 is a method including storing an encoded pointer for a memory address to a memory allocation of a memory in a register in a processor, the encoded pointer including a first even odd slot (EOS) bit set to a first value and a second EOS bit set to a second value; receiving a memory access request based on the encoded pointer; comparing the first value to the second value; and performing a memory operation corresponding to the memory access request when the first value matches the second value. In Example 15, the subject matter of Example 14 may optionally include generating a bounds violation fault in response to determining that the first value does not match the second value. In Example 16, the subject matter of Example 14 may optionally include wherein the first EOS bit indicates whether the memory allocation is in an even slot of the memory or an odd slot of the memory. In Example 17, the subject matter of Example 14 may optionally include the encoded pointer including a first supervisor bit set to a third value and a second supervisor bit set to a fourth value and comprising generating a general protection fault in response to determining that the third value does not match the fourth value. In Example 18, the subject matter of Example 14 may optionally include wherein the encoded pointer comprises a slotted memory pointer and the first EOS bit comprises a least significant slot index bit of a plurality of slot index bits. In Example 19, the subject matter of Example 18 may optionally include wherein the plurality of slot index bits indicates an index of a selected slot within a set of all slots for a selected slot size.

In Example 20, the subject matter of Example 14 may optionally include copying the first EOS bit to the second EOS bit, the second EOS bit being a previously unused bit of the encoded pointer. In Example 21, the subject matter of Example 14 may optionally include wherein the encoded pointer comprises a slotted memory pointer and comprising deterministically detecting that a memory access of the memory operation at least one of underflows and overflows a slot boundary to an adjacent byte outside of a slot associated with the encoded pointer. In Example 22, the subject matter of Example 14 may optionally include duplicating at least one address bit in the encoded pointer that is constant across all encoded pointers to all valid locations within an allocation of memory as the first EOS bit. In Example 23, the subject matter of Example 14 may optionally include comparing the first value to the second value when the encoded pointer is dereferenced. In Example 24, the subject matter of Example 14 may optionally include wherein at least one of an underflow and an overflow, resulting from the memory operation, into an adjacent byte of a slot flips the first EOS bit. In Example 25, the subject matter of Example 14 may optionally include comparing the first value to the second value to detect an out-of-bounds (00B) memory access in adjacent slots of memory when the first value does not match the second value.

Example 26 is a system, including a memory to store a memory allocation; and a processing core including a register to store an encoded pointer for a memory address to the memory allocation of the memory, the encoded pointer including a first even odd slot (EOS) bit set to a first value and a second EOS bit set to a second value; and circuitry to receive a memory access request based on the encoded pointer; and in response to determining that the first value matches the second value, perform a memory operation corresponding to the memory access request. In Example 27, the subject matter of Example 26 may optionally include the circuitry to generate a bounds violation fault in response to determining that the first value does not match the second value. In Example 28, the subject matter of Example 26 may optionally include wherein the first EOS bit indicates whether the memory allocation is in an even slot of the memory or an odd slot of the memory. In Example 29, the subject matter of Example 26 may optionally include the encoded pointer including a first supervisor bit set to a third value and a second supervisor bit set to a fourth value and comprising the circuitry to generate a general protection fault in response to determining that the third value does not match the fourth value. In Example 30, the subject matter of Example 26 may optionally include wherein the encoded pointer comprises a slotted memory pointer and the first EOS bit comprises a least significant slot index bit of a plurality of slot index bits.

Example 31 is an apparatus operative to perform the method of any one of Examples 14 to 25. Example 32 is an apparatus that includes means for performing the method of any one of Examples 14 to 25. Example 33 is an apparatus that includes any combination of modules and/or units and/or logic and/or circuitry and/or means operative to perform the method of any one of Examples 14 to 25. Example 34 is an optionally non-transitory and/or tangible machine-readable medium, which optionally stores or otherwise provides instructions that if and/or when executed by a computer system or other machine are operative to cause the machine to perform the method of any one of Examples 14 to 25.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

1. An apparatus, comprising:
processor circuitry including at least one processing core circuitry, the at least one processing core circuitry including
a register to store an encoded pointer for a memory address to a memory allocation of a memory, the encoded pointer including slot index bits, having a first even odd slot (EOS) bit set to a first value, and a second EOS bit set to a second value; and
circuitry to receive a memory access request based on the encoded pointer; and in response to determining that the first EOS bit matches the second EOS bit, perform a memory operation corresponding to the memory access request.

2. The processor of claim 1, comprising the circuitry to generate a bounds violation fault in response to determining that the first EOS bit does not match the second EOS bit.

3. The processor of claim 1, wherein the first EOS bit indicates whether the memory allocation is in an even slot of the memory or an odd slot of the memory.

4. The processor of claim 1, the encoded pointer including a first supervisor bit set to a third value and a second supervisor bit set to a fourth value and comprising the circuitry to generate a general protection fault in response to determining that the first supervisor bit does not match the second supervisor bit.

5. The processor of claim 1, wherein the encoded pointer comprises a slotted memory pointer and the first EOS bit comprises a least significant slot index bit of a plurality of slot index bits.

6. The processor of claim 5, wherein the plurality of slot index bits indicates an index of a selected slot within a set of all slots for a selected slot size.

7. The processor of claim 1, wherein the circuitry is to copy the first EOS bit to the second EOS bit, the second EOS bit being a previously unused bit of the encoded pointer.

8. The processor of claim 1, wherein the encoded pointer comprises a slotted memory pointer and wherein the circuitry is to detect that a memory access of the memory operation at least one of underflows and overflows a slot boundary to an adjacent byte outside of a slot associated with the encoded pointer.

9. The processor of claim 1, comprising the circuitry to duplicate at least one address bit in the encoded pointer that is constant across all encoded pointers to all valid locations within an allocation of memory as the first EOS bit.

10. The processor of claim 1, comprising the circuitry to compare the first EOS bit to the second EOS bit when the encoded pointer is dereferenced.

11. The processor of claim 1, wherein at least one of an underflow and an overflow, resulting from the memory operation, into an adjacent byte of a slot flips the first EOS bit.

12. The processor of claim 1, comprising the circuitry to compare the first EOS bit to the second EOS bit to detect an out-of-bounds (00B) memory access in adjacent slots of memory when the first EOS bit does not match the second EOS bit.

13. The processor of claim 1, wherein the encoded pointer includes a plurality of adjust bits to select fractional offsets of a power of two size from a power of two starting position.

14. A method comprising:
storing, by processor circuitry, an encoded pointer for a memory address to a memory allocation of a memory in a register in the processor, the encoded pointer including slot index bits, having a first even odd slot (EOS) bit set to a first value, and a second EOS bit set to a second value;
receiving, in the processor circuitry, a memory access request based on the encoded pointer;
comparing, by the processor circuitry, the first EOS bit to the second EOS; and
performing, by the processor circuitry, a memory operation corresponding to the memory access request when the first EOS matches the second EOS.

15. The method of claim 14, comprising generating a bounds violation fault by the processor circuitry in response to determining that the first EOS bit does not match the second EOS bit.

16. The method of claim 14, wherein the first EOS bit indicates whether the memory allocation is in an even slot of the memory or an odd slot of the memory.

17. The method of claim 14, the encoded pointer including a first supervisor bit set to a third value and a second supervisor bit set to a fourth value and comprising generating a general protection fault by the processor circuitry in response to determining that the first supervisor bit does not match the second supervisor bit.

18. The method of claim 14, wherein the encoded pointer comprises a slotted memory pointer and the first EOS bit comprises a least significant slot index bit of a plurality of slot index bits.

19. The method of claim 18, wherein the plurality of slot index bits indicates an index of a selected slot within a set of all slots for a selected slot size.

20. The method of claim 14, comprising copying the first EOS bit to the second EOS bit, the second EOS bit being a previously unused bit of the encoded pointer.

21. A system, comprising:
memory circuitry to store a memory allocation; and
processor circuitry including at least one a processing core circuitry, the at least one processing core circuitry including
a register to store an encoded pointer for a memory address to the memory allocation of the memory, the encoded pointer including slot index bits, having a first even odd slot (EOS) bit set to a first value, and a second EOS bit set to a second value; and
circuitry to receive a memory access request based on the encoded pointer; and in response to determining that the first EOS matches the second EOS, perform a memory operation corresponding to the memory access request.

22. The system of claim 21, comprising the circuitry to generate a bounds violation fault in response to determining that the first EOS bit does not match the second EOS bit.

23. The system of claim 22, wherein the first EOS bit indicates whether the memory allocation is in an even slot of the memory or an odd slot of the memory.

24. The system of claim 22, the encoded pointer including a first supervisor bit set to a third value and a second supervisor bit set to a fourth value and comprising the circuitry to generate a general protection fault in response to determining that the first supervisor bit does not match the second supervisor bit.

25. The system of claim 22, wherein the encoded pointer comprises a slotted memory pointer and the first EOS bit comprises a least significant slot index bit of a plurality of slot index bits.
